(19) United States
(12) Patent Application Publication
(10) Pub. No.: US 2026/0127963 A1
(43) Pub. Date: May 7, 2026

(54) TRAFFIC LIGHT CLASSIFICATION FOR AUTONOMOUS OR SEMI-AUTONOMOUS SYSTEMS AND APPLICATIONS

(71) Applicant: NVIDIA Corporation, Santa Clara, CA (US)

(72) Inventors: Rui Shen, San Jose, CA (US); Dong Zhang, Church Hill, TN (US)

(21) Appl. No.: 18/938,057

(22) Filed: Nov. 5, 2024

(51) Int. Cl. G08G 1/097; G06V 10/764; G06V 10/80; G06V 10/82

(52) U.S. Cl. CPC G08G 1/097; G06V 10/765; G06V 10/803; G06V 10/82

(57) ABSTRACT

In various examples, the systems and methods of the present disclosure may train and use machine learning models to determine attributes and, in some instances, classifications associated with traffic lights to determine traffic rules for operating a machine (e.g., an autonomous or semi-autonomous machine or vehicle) in an environment. For instance, an image depicting a traffic light device may be applied to a machine learning model that includes a plurality of component heads. Each one of component heads may be trained to detect different attributes and/or combinations of attributes associated with the traffic light device. Additionally, in some examples, the machine learning model may include a fusion head that is trained to classify the traffic light device. For instance, the fusion head may classify the traffic light device using the detected attributes and/or using a combined feature vector of multiple feature vectors applied to the plurality of component heads.

### BACKGROUND

For an autonomous or semi-autonomous vehicle to navigate safely through an environment, the vehicle may, at times, need to correctly determine states of traffic lights. This capability may help ensure that the vehicle understands the traffic rules currently in place at a certain location or junction. However, the physical characteristics (e.g., appearance) of traffic lights generally vary from one geographic region to another. For instance, across different geographic regions, traffic lights may include a variety of different shapes, orientations, numbers of light bulbs, colors of light bulbs, shapes of light bulbs, and/or other physical features. As such, correctly identifying the traffic rules conveyed by the state of a specific traffic light may be difficult across a wide variety of scenarios.

### SUMMARY

Embodiments of the present disclosure relate to traffic light classification for autonomous or semi-autonomous systems and applications. Systems and methods are disclosed that may train and use machine learning models to determine attributes and, in some instances, classifications associated with traffic lights to determine traffic rules for operating a machine (e.g., an autonomous or semi-autonomous machine or vehicle) in an environment. For instance, an image depicting a traffic light device may be applied to a machine learning model that includes a plurality of component heads. Each component head of the plurality of component heads may be trained to detect different attributes and/or combinations of attributes associated with the traffic light device, such as active bulb colors and/or shapes, number of bulbs, housing orientation, and/or any other attributes. In some examples, the machine learning model may include a fusion head that is trained to classify the traffic light device. For instance, the fusion head may classify the traffic light device using the detected attributes or embeddings from the plurality of component heads, and/or using a combined feature vector of multiple feature vectors applied to the plurality of component heads. Using the detected attributes and/or the classification of the traffic light device, the systems of the present disclosure may cause the machine to perform one or more control operations.

In contrast to conventional systems, the systems of the present disclosure, in some embodiments, are able to use a multi-component machine learning architecture to classify each component (e.g., where each component may represent one or more attributes of a traffic light) and, in some instances, use a fusion classifier to fuse the features from each component head to predict a final class of the traffic light. For instance, the systems of the present disclosure may use a multi-component machine learning model to decompose a traffic light into multiple components, where active bulb state may be one of the components, and then a fusion head within the model may be used to predict the final traffic light class by combining all these components, allowing cross-checks between components and removing or reducing post-processing, in some instances. Additionally, in contrast to conventional systems, the systems of the present disclosure may apply implicit negative training targets to the machine learning models during training for each negative sample, and map the negative samples to a uniform distribution, which allows the models to better distinguish valid samples from unknown or invalid samples, thereby reducing false-positive activations in each component and in fusion.

### BRIEF DESCRIPTION OF THE DRAWINGS

The present systems and methods for traffic light classification for autonomous or semi-autonomous systems and applications are described in detail below with reference to the attached drawing figures, wherein:

FIG. 1 is a data flow diagram illustrating an example of a process for traffic light classification using a multi-component machine learning model, in accordance with some embodiments of the present disclosure;

FIG. 2 is an illustration of an image crop depicting a traffic light, the image crop obtained from image data representing an image of an environment, in accordance with some embodiments of the present disclosure;

FIG. 3 illustrates various examples of traffic light configurations and states that may be classified using a multi-component machine learning model, in accordance with some embodiments of the present disclosure;

FIG. 4 illustrates an example of using a multi-component machine learning model architecture to predict attributes and/or classifications of traffic lights from image data, in accordance with some embodiments of the present disclosure;

FIG. 5 is a data flow diagram illustrating an example process for training one or more machine learning models to predict traffic light classes and/or attributes, in accordance with some embodiments of the present disclosure;

FIG. 6 illustrates an example of a system that may perform one or more of the processes described herein, in accordance with some embodiments of the present disclosure;

FIG. 7 is a flow diagram illustrating an example of a method for traffic light classification, in accordance with some embodiments of the present disclosure;

FIG. 8 is a flow diagram illustrating an example of a method for determining traffic light attributes using a multi-component machine learning model, in accordance with some embodiments of the present disclosure;

FIG. 9 is a flow diagram illustrating an example of a method for training a multi-component machine learning model to predict traffic light attributes and/or classes, in accordance with some embodiments of the present disclosure;

FIG. 10A is an illustration of an example autonomous vehicle, in accordance with some embodiments of the present disclosure;

FIG. 10B is an example of camera locations and fields of view for the example autonomous vehicle of FIG. 10A, in accordance with some embodiments of the present disclosure;

FIG. 10C is a block diagram of an example system architecture for the example autonomous vehicle of FIG. 10A, in accordance with some embodiments of the present disclosure;

FIG. 10D is a system diagram for communication between cloud-based server(s) and the example autonomous vehicle of FIG. 10A, in accordance with some embodiments of the present disclosure;

FIG. 11 is a block diagram of an example computing device suitable for use in implementing some embodiments of the present disclosure; and

FIG. 12 is a block diagram of an example data center suitable for use in implementing some embodiments of the present disclosure.

### DETAILED DESCRIPTION

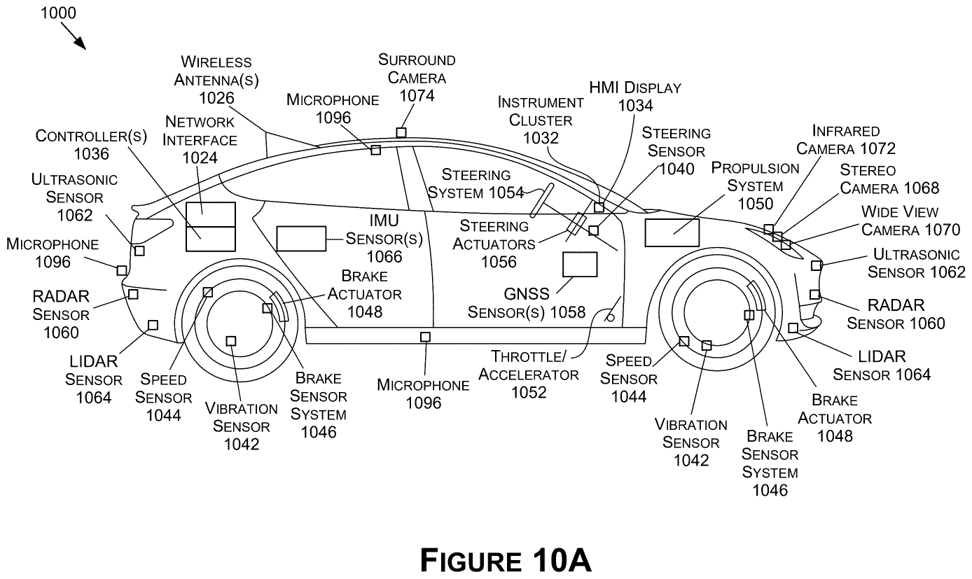

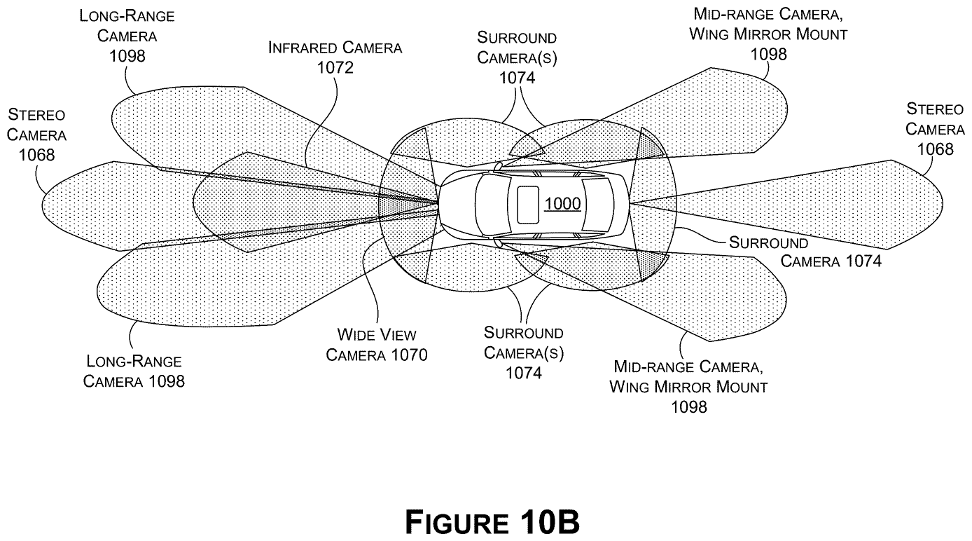

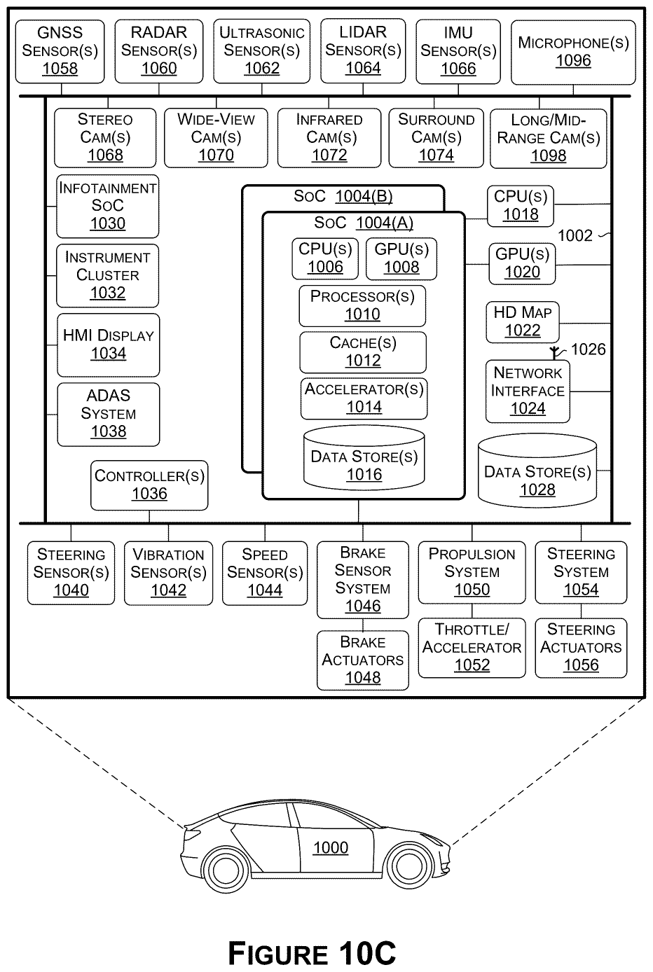

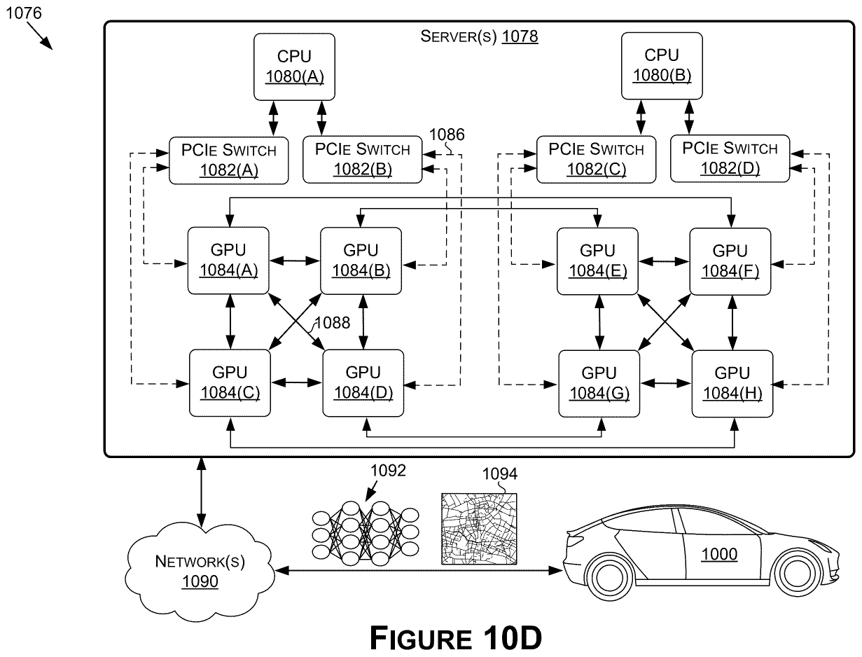

Systems and methods are disclosed related to traffic light classification for autonomous or semi-autonomous systems and applications. Although the present disclosure may be described with respect to an example autonomous or semi-autonomous vehicle or machine 1000 (alternatively referred to herein as “vehicle 1000,” “ego-vehicle 1000,” “ego-machine 1000,” or “machine 1000,” an example of which is described with respect to FIGS. 10A-10D), this is not intended to be limiting. For example, the systems and methods described herein may be used by, without limitation, non-autonomous vehicles or machines, semi-autonomous vehicles or machines (e.g., in one or more adaptive driver assistance systems (ADAS)), autonomous vehicles or machines, piloted and un-piloted robots or robotic platforms, autonomous mobile robots (AMRs), humanoid robots, warehouse vehicles, off-road vehicles, vehicles coupled to one or more trailers, flying vessels, boats, shuttles, emergency response vehicles, motorcycles, electric or motorized bicycles, aircraft, construction vehicles, underwater craft, drones, and/or other vehicle types. In addition, although the present disclosure may be described with respect to traffic light classification for autonomous or semi-autonomous driving, this is not intended to be limiting, and the systems and methods described herein may be used in augmented reality, virtual reality, mixed reality, robotics, security and surveillance, autonomous or semi-autonomous machine applications, and/or any other technology spaces where attribute-based classification may be used.

As described above, traffic lights may have a large variety across different regions. For example, each bulb of a traffic light may have a different shape and color, and a traffic light may have multiple active bulbs (e.g., illuminated, turned on, etc.) at the same time. Although traffic lights may have a large variety across different regions, traffic lights are usually all constructed from a relatively small number of components. Because of this, and as described herein, a concise model architecture may be used to classify an input image or image crop into one class of traffic light. For instance, instead of directly predicting a final traffic light class, the model(s) trained and used by the systems of the present disclosure may predict classes of different components of a traffic light using a common backbone and different component heads, where each component head may have one or more valid outputs. In some examples, each component may represent or correspond to one or more attributes of the traffic light. Examples of attributes may include, but are not limited to, orientation of the traffic light, road users that the traffic light applies to (e.g., vehicles, pedestrians, cyclists, etc.), traffic light housing shape, whether a traffic light is occluded, active bulb color(s), active bulb shape(s), or any other attributes. In some instances, the systems may use a fusion head of the model(s) to combine embeddings from the different component heads to output a final traffic light class. Additionally, in some examples, to reduce false positive activations in each component head and/or in the fusion head, the systems of the present disclosure may apply implicit negative training targets for each negative sample. For instance, the systems of the present disclosure may map negative samples to a uniform distribution, which may help the model(s) to better distinguish valid samples from unknown or invalid samples.

By way of example, and not limitation, a system(s) may obtain image data representing an image (e.g., an image crop of a parent image) that depicts a traffic light, and the system(s) may apply the image to one or more machine learning models (e.g., one or more deep neural networks (DNNs)). Although examples are described herein with respect to using neural networks, and specifically DNNs in machine learning models, this is not intended to be limiting. For example, and without limitation, any of the various machine learning models and/or neural networks described herein may include any type of machine learning model, such as a machine learning model(s) using linear regression, logistic regression, decision trees, support vector machines (SVM), Naïve Bayes, k-nearest neighbor (Knn), K means clustering, random forest, dimensionality reduction algorithms, gradient boosting algorithms, neural networks (e.g., auto-encoder neural networks, artificial neural networks (ANNs), convolutional neural networks (CNNs), recurrent neural networks (RNNs), perceptrons, Long/Short Term Memory (LSTM) networks, multi-layer perceptron (MLP) networks, deep stacking networks (DSNs), generative pre-training (GPT) models or networks, feed forward networks, radial basis function ANNs, self-organizing maps (SOMs), Kohonen maps, Hopfield networks, Boltzmann machine, deep belief neural networks, deconvolutional neural networks, generative adversarial networks (GANs), liquid state machines, modular neural networks, liquid state machines, sequence-to-sequence models, networks using transformer architectures, diffusion models (e.g., diffusion probabilistic models, score-based generative models, etc.), neural rendering field (NeRF) models, models with encoder-only architectures, models with decoder-only architectures, models with encoder-decoder architectures, generative machine learning models, language models, large language models (LLMs), vision language models (VLMs), multi-modal language models (MMLMs), etc.), and/or other types of machine learning models.

As described herein, in some examples, the machine learning model(s) may include a multi-component architecture. That is, the machine learning model(s) may include a plurality of component heads, and each component head may be trained to detect one or more attributes of the traffic light depicted in the image. For instance, the machine learning model(s) may include a first component head that is trained to predict one or more first attributes of the traffic light (e.g., orientation), a second component head that is trained to predict one or more second attributes of the traffic light (e.g., housing shape), a third component head that is trained to predict one or more third attributes of the traffic light (e.g., active bulb color(s) and/or shape(s)), and so forth. In various examples, a single component head may have more than one valid output for a given input image. As an example, a component head that is to predict active bulb shapes may output an indication that the active bulbs of a traffic light include a round bulb and an arrow bulb.

In some examples, the machine learning model(s) may include a common backbone that generates a shared feature vector from the input image. The machine learning model(s) may extract various features from the shared feature vector to generate component-specific feature vectors that are to be applied to each of the component heads of the model(s). For instance, the machine learning model(s) may use the shared feature vector to generate a first component feature vector to be applied to a first component head of the model(s), generate a second component feature vector to be applied to a second component head of the model(s), and so forth. In such examples, the features included in the component-specific feature vectors may allow the component heads to make accurate predictions. In other words, the component-specific feature vectors may include features from the shared feature vector that are usable by the component head to predict attributes it is trained to identify, while excluding features from the shared feature vector that are not usable by the component head. For example, a component feature vector that is applied to a component head for predicting traffic light orientation may exclude features relating to active bulb colors, and vice-versa.

In various examples, the machine learning model(s) may apply the component-specific feature vectors to the component heads, and the component heads may output probability vectors indicative of the attributes associated with the traffic light device depicted in the input image. For instance, a probability vector for active bulb color attributes may include entries indicating the probability or confidence of the active bulb color for the traffic light. As an example, if the active bulb color is green, then the entries in the probability vector for the bulb being red or yellow may be a low value (e.g., 1%), while the entry for the bulb color being green may be a higher value (e.g., 98%). In some examples, the traffic light attributes the component heads may predict may include, but are not limited to, orientation, housing shape, active bulb color, active bulb shape, bulb count, occlusion (e.g., whether the light is occluded by other objects), truncation (e.g., where the light is truncated by the image border), road user (e.g., which type(s) of road user(s) the traffic light applies to), and/or blinking state. For instance, the orientation of the traffic light may include one or more of whether the traffic light is front facing, non-front facing, back, left, right, unknown, etc. As another example, the housing shape may be vertical, horizontal, dog house, pedestrian hybrid beacon, unknown, etc. Active bulb colors may include red, yellow, green, white, orange, unknown, or any other color. Active bulb shapes may include, in some instances, a circle, arrow straight, arrow left, arrow right, arrow down, arrow U-turn, bus, digit (e.g., countdown timer), tram, train, bike, pedestrian, hand, unknown, or any other shape.

In some instances, the machine learning model(s) may also include a fusion head that is trained to predict a final classification of the traffic light depicted in the input image. In some examples, the fusion head may predict the final classification of the traffic light based on the attributes of the traffic light determined by the component heads. Additionally, or alternatively, the fusion head may classify the traffic light based on a combined feature vector that includes one or more features from the component-specific feature vectors. In some examples, the final classification of the traffic light may include a combination of one or more of the detected attributes. For instance, the final classification may include or indicate a summary of the most important attributes of the traffic light that relate to the current state of the traffic light and/or the traffic rules being conveyed by the traffic light.

In some examples, based at least on the attributes and/or classification of the traffic light determined by the machine learning model(s), the system(s) of the present disclosure may cause a machine to perform one or more operations. For instance, the system(s) of the present disclosure may use the attributes and/or classification of the traffic light to determine the active traffic rules for a current lane segment the machine is operating in. Based on the traffic rules, the system(s) may cause the machine to perform one or more operations in accordance with the traffic rules (e.g., stop, go, turn, yield, etc.).

As described herein, the system(s) may also train the machine learning model(s) to predict the attributes and/or classifications of the traffic lights. In some examples, in order to reduce false positive activations in each component head and in the fusion head, the system(s) may apply implicit negative training targets for each negative sample, and map negative samples to a uniform distribution output. In this way, the machine learning model(s) may better distinguish valid samples from unknown or invalid samples.

In some instances, when a component head (e.g., orientation) is allowed to have only one valid output, the system(s) may apply softmax activation. For instance, the implicit negative training target for a negative sample may be an above-zero uniform distribution. The sum of the uniform distribution may not necessarily sum up to one, but may need to be smaller than the confidence threshold to be applied at test time. In this way, the confidence threshold applied at test time may determine whether a test sample is a negative sample or a positive sample. If the maximum activation across all classes is below the threshold, then the sample may be a negative sample for that component or fusion head. Otherwise, the sample may be a positive sample for that component or fusion head, and the maximum activation across all classes may become the predicted class. In some examples, cross-entropy loss or any other single-label loss function (e.g., focal loss), label smoothing, and/or any other regularization method may be applied during training.

On the other hand, when a component head (e.g., color-shape) is allowed to have more than one valid output, the system(s) may apply sigmoid activation. For instance, the implicit negative training target for a negative sample may be an all-zero uniform distribution. If the maximum activation across all classes is below the confidence threshold applied at test time, then the sample may a negative sample for that component or fusion head. Otherwise, the sample may be a positive sample for that component or fusion head, and any class with a probability at or above the confidence threshold may become one predicted class. In some examples, binary cross-entropy loss or any other multi-label loss function (e.g., binary focal loss), label smoothing, and any other regularization methods may be applied during training.

In various instances, to work with the multi-component model architecture, the system(s) of the present disclosure may use data augmentation methods to selectively update one or more components and the fusion class. These data augmentation methods may include classical image processing methods, style transfer methods, or any other methods. As an example, the system(s) may perform data augmentation to generate training samples of stateless lights by using image processing techniques to turn the red/green/yellow lights off. That is, the system(s) may identify the pixels which have strong red/green/yellow color and intensity, and then modify those pixels to make them look similar to surrounding pixels. For example, for a red light, the system(s) may use a threshold in Hue, Saturation, and Value (HSV) color space to detect the pixels with higher red values and brightness, and then change the saturation to small value and brightness to be similar to surrounding pixels. In another example, the system(s) may perform grayscale augmentation to turn an image into a grayscale image so that no color information may be available, as well as change the label class to stateless. Using such techniques, the system(s) may force the neural network to learn the concept of colors.

Additionally, or alternatively, the system(s) may use style transfer augmentation to train a neural network to learn the mapping between red/green/yellow lights to gray/stateless lights, or use a style transfer augmentation neural network to turn any traffic lights to green. As another example, the system(s) may use style transfer augmentation to change the shape and/or other properties of the light bulbs. For example, the system(s) may change the shape of a traffic light bulb(s) from one shape to another shape, such as from a circle to a left arrow, for instance. Additionally, these techniques may be applied to change other properties of a traffic light as well, such as number of light bulbs, housing shapes, etc.

In some embodiments, the systems and methods described herein may be performed within a simulation environment (e.g., NVIDIA's DriveSIM, IsaacSIM, and/or IsaacGYM) using simulated data (e.g., simulated sensor data of simulated sensors of a virtual or simulated machine). For example, simulated input data (e.g., simulated images depicting traffic lights) may be used to determine traffic light attributes and/or classifications, and this information may be used to perform operations associated with the virtual machine within the simulation environment. These simulated operations may be used to test performance of the underlying algorithms, systems, and/or processes prior to deploying them in the real-world. In some instances, the simulation may be used to generate synthetic training data—e.g., image data representing images of various traffic light devices from within the simulation. The synthetic training data (in addition to or alternatively from real-world data) may then be used to train machine learning models (e.g., DNNs) to classify traffic lights to determine traffic rules conveyed by different states of the traffic lights.

In any example, such as where a simulation environment is used for testing, validation, training, etc., the simulation environment and/or associated training data may be rendered or otherwise generated using one or more light transport algorithms—such as ray-tracing and/or path-tracing algorithms. In some embodiments, the simulation environment and/or one or more objects, features, or components thereof (e.g., traffic lights) may be generated or managed within a three-dimensional (3D) content collaboration platform (e.g., NVIDIA's OMNIVERSE) for industrial digitalization, generative physical AI, and/or other use cases, applications, or services. For example, the content collaboration platform or system may include a system for using or developing universal scene descriptor (USD) (e.g., OpenUSD) data for managing objects, features, scenes, etc. within a simulated environment, digital environment, etc. The platform may include real physics simulation, such as using NVIDIA's PhysX SDK, in order to simulate real physics and physical interactions with simulations hosted by the platform. The platform may integrate OpenUSD along with ray tracing/path tracing/light transport simulation (e.g., NVIDIA's RTX rendering technologies) into software tools and simulation workflows for building, training, deploying, or testing AI systems—such as systems for testing, validating, training (e.g., machine learning models, neural networks, etc.), and/or other tasks related to automotive, robotics, machines, and/or other applications. In some examples, the simulation environment may include a digital twin of a real environment, such as a digital twin of a specific stretch of roadway, a warehouse, a data center, a factory, an airport, a geographic area, a marine area, or any other real environment where autonomous or semi-autonomous machines may operate.

In some embodiments, teleoperation or remote control of a vehicle or other machine may be performed using a remote control or teleoperation system. For example, the systems and methods described herein may be used to classify traffic lights to aid a remote operator in controlling—or providing waypoints or other indications of control or navigation—an autonomous or semi-autonomous machine through an environment.

In some examples, the machine learning model(s) (e.g., deep neural networks, language models, LLMs, VLMs, multi-modal language models, perception models, tracking models, fusion models, transformer models, diffusion models, encoder-only models, decoder-only models, encoder-decoder models, neural rendering field (NERF) models, etc.) described herein may be packaged as a microservice—such as an inference microservice (e.g., NVIDIA NIMs)—which may include a container (e.g., an operating system (OS)-level virtualization package) that may include an application programming interface (API) layer, a server layer, a runtime layer, and/or a model “engine.” For example, the inference microservice may include the container itself and the model(s) (e.g., weights and biases). In some instances, such as where the machine learning model(s) is small enough (e.g., has a small enough number of parameters), the model(s) may be included within the container itself. In other examples—such as where the model(s) is large—the model(s) may be hosted/stored in the cloud (e.g., in a data center) and/or may be hosted on-premises and/or at the edge (e.g., on a local server or computing device, but outside of the container). In such embodiments, the model(s) may be accessible via one or more APIs-such as REST APIs. As such, and in some embodiments, the machine learning model(s) described herein may be deployed as an inference microservice to accelerate deployment of a model(s) on any cloud, data center, or edge computing system, while ensuring the data is secure. For example, the inference microservice may include one or more APIs, a pre-configured container for simplified deployment, an optimized inference engine (e.g., built using a standardized AI model deployment an execution software, such as NVIDIA's Triton Inference Server, and/or one or more APIs for high performance deep learning inference, which may include an inference runtime and model optimizations that deliver low latency and high throughput for production applications - such as NVIDIA's TensorRT), and/or enterprise management data for telemetry (e.g., including identity, metrics, health checks, and/or monitoring). The machine learning model(s) described herein may be included as part of the microservice along with an accelerated infrastructure with the ability to deploy with a single command and/or orchestrate and auto-scale with a container orchestration system on accelerated infrastructure (e.g., on a single device up to data center scale). As such, the inference microservice may include the machine learning model(s) (e.g., that has been optimized for high performance inference), an inference runtime software to execute the machine learning model(s) and provide outputs/responses to inputs (e.g., user queries, prompts, etc.), and enterprise management software to provide health checks, identity, and/or other monitoring. In some embodiments, the inference microservice may include software to perform in-place replacement and/or updating to the machine learning model(s). When replacing or updating, the software that performs the replacement/updating may maintain user configurations of the inference runtime software and enterprise management software.

The systems and methods described herein may be used by, without limitation, non-autonomous vehicles or machines, semi-autonomous vehicles or machines (e.g., in one or more adaptive driver assistance systems (ADAS)), autonomous vehicles or machines, piloted and un-piloted robots or robotic platforms, warehouse vehicles, off-road vehicles, vehicles coupled to one or more trailers, flying vessels, boats, shuttles, emergency response vehicles, motorcycles, electric or motorized bicycles, aircraft, construction vehicles, underwater craft, drones, and/or other vehicle types. Further, the systems and methods described herein may be used for a variety of purposes, by way of example and without limitation, for machine control, machine locomotion, machine driving, synthetic data generation, model training, perception, augmented reality, virtual reality, mixed reality, robotics, security and surveillance, simulation and digital twinning, autonomous or semi-autonomous machine applications, deep learning, environment simulation, object or actor simulation and/or digital twinning, data center processing, conversational AI, light transport simulation (e.g., ray-tracing, path tracing, etc.), collaborative content creation for 3D assets, cloud computing and/or any other suitable applications.

Disclosed embodiments may be comprised in a variety of different systems such as automotive systems (e.g., a control system for an autonomous or semi-autonomous machine, a perception system for an autonomous or semi-autonomous machine), systems implemented using a robot, aerial systems, medial systems, boating systems, smart area monitoring systems, systems for performing deep learning operations, systems for performing simulation operations, systems for performing digital twin operations, systems implemented using an edge device, systems implementing language models, such as large language models (LLMs), vision language models (VLMs), and/or multi-modal language models, systems implementing one or more vision language models (VLMs), systems implementing one or more multi-modal language models, systems using or deploying one or more inference microservices, systems that incorporate deploy one or more machine learning models in a service or microservice along with an OS-level virtualization package (e.g., a container), systems incorporating one or more virtual machines (VMs), systems for performing synthetic data generation operations, systems implemented at least partially in a data center, systems for performing conversational AI operations, systems for performing light transport simulation, systems for performing collaborative content creation for 3D assets, systems for performing generative AI operations, systems implemented at least partially using cloud computing resources, and/or other types of systems.

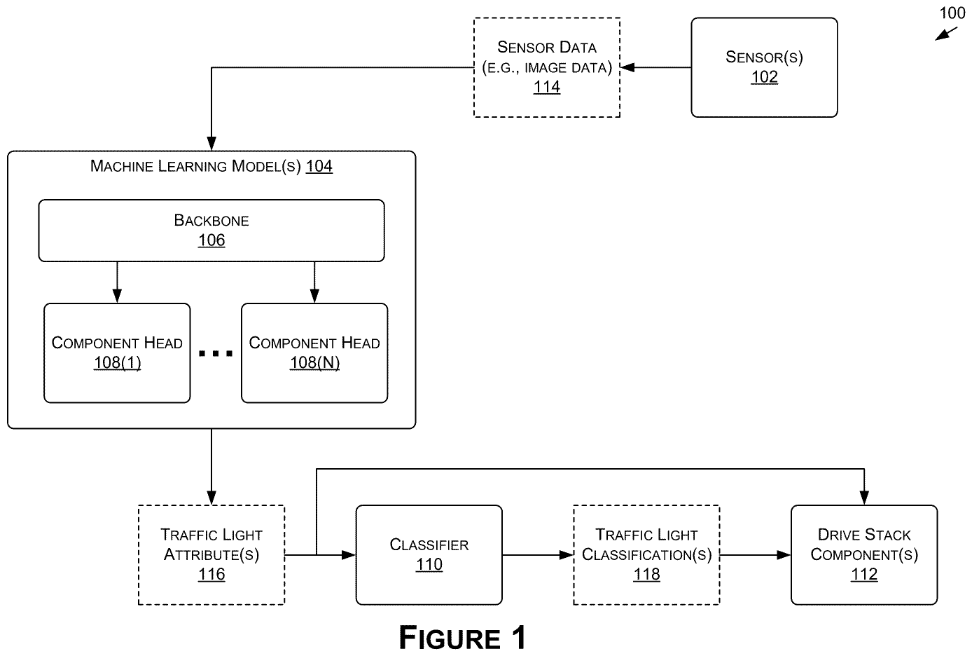

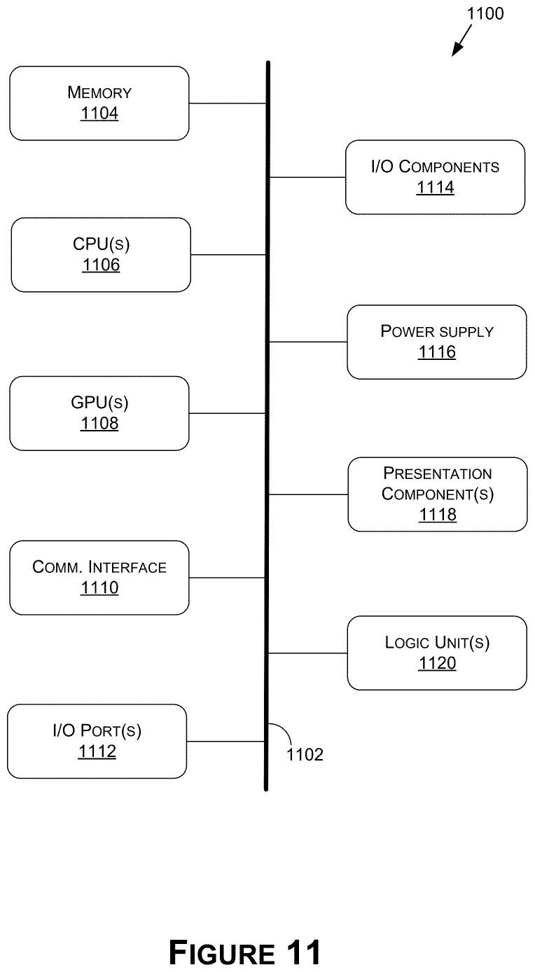

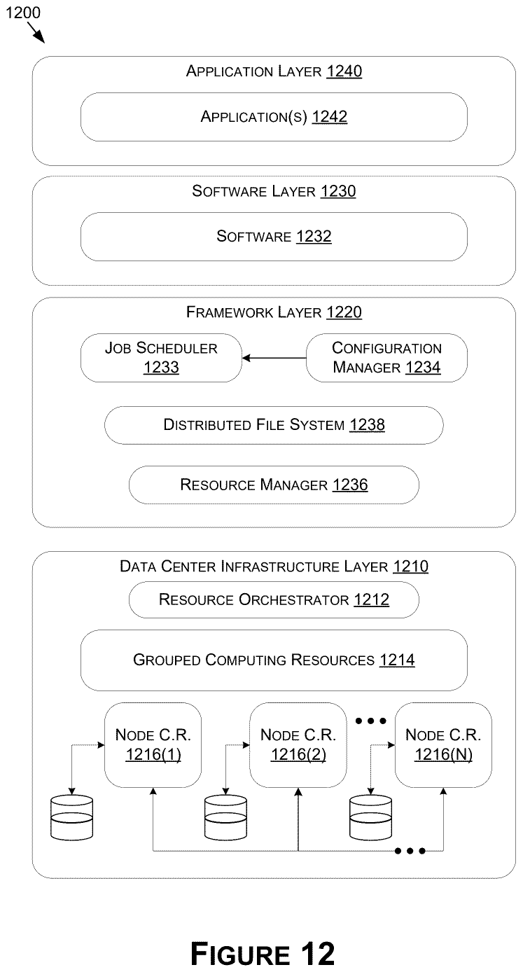

With reference to FIG. 1, FIG. 1 is a data flow diagram illustrating an example of a process 100 for traffic light classification using a multi-component machine learning model, in accordance with some embodiments of the present disclosure. It should be understood that this and other arrangements described herein are set forth only as examples. Other arrangements and elements (e.g., machines, interfaces, functions, orders, groupings of functions, etc.) may be used in addition to or instead of those shown, and some elements may be omitted altogether. Further, many of the elements described herein are functional entities that may be implemented as discrete or distributed components or in conjunction with other components, and in any suitable combination and location. Various functions described herein as being performed by entities may be carried out by hardware, firmware, and/or software. For instance, various functions may be carried out by a processor executing instructions stored in memory. In some embodiments, the systems, methods, and processes described herein may be executed using similar components, features, and/or functionality to those of example autonomous vehicle 1000 of FIGS. 10A-10D, example computing device 1100 of FIG. 11, and/or example data center 1200 of FIG. 12.

The process 100 may be implemented using, amongst additional or alternative components, one or more sensors 102, one or more machine learning models 104, which may include a common backbone 106 and a plurality of component heads 108(1)-108(N) (hereinafter referred to collectively as “component heads 108”), a classifier 110, and one or more drive stack components 112. As a brief overview of the process 100, the sensor(s) 102 may generate sensor data 114 (e.g., image data representing an image of a traffic light) that is applied to the machine learning model(s) 104. The backbone 106 of the model(s) 104 may generate a plurality of features (e.g., feature vectors) and/or embeddings that are fed into the different component heads 108. The component heads 108 may predict one or more traffic light attributes 116, which may be sent to the drive stack component(s) 112. Additionally, or alternatively, the traffic light attribute(s) 116 may be used by the classifier 110 (which may be part of the machine learning model(s) 104 or separate from the model(s) 104) to determine one or more traffic light classifications 118, which may also be sent to the drive stack component(s) 112. The drive stack component(s) 112 may use the traffic light attribute(s) 116 and/or the traffic light classification(s) 118 to cause a machine (e.g., the vehicle 1000) to perform one or more operations.

In some examples, the sensor(s) 102 may include any one or more of the sensors of the vehicle 1000. For instance, the sensor(s) 102 may include one or more of a LiDAR sensor(s), a RADAR sensor(s), an image sensor(s) (e.g., a camera(s)), an ultrasonic sensor(s), or any other sensors described herein. As such, the sensor data 114 may include LiDAR data generated using the LiDAR sensor(s), RADAR data generated using the RADAR sensor(s), image data generated using the image sensor(s), ultrasonic data generated using the ultrasonic sensor(s), or any other type of sensor data.

In some examples, the sensor data 114 may be captured in one format (e.g., RCCB, RCCC, RBGC, etc.), and then converted (e.g., during pre-processing of the sensor data) to another format. In some other examples, the sensor data 114 may be provided as input to a sensor data or image data pre-processor (not shown) to generate pre-processed image data. Many types of images or formats may be used as inputs; for example, compressed images such as in Joint Photographic Experts Group (JPEG), Red Green Blue (RGB), or Luminance/Chrominance (YUV) formats, compressed images as frames stemming from a compressed video format (e.g., H.264/Advanced Video Coding (AVC), H.265/High Efficiency Video Coding (HEVC), VP8, VP9, Alliance for Open Media Video 1 (AV1), Versatile Video Coding (VVC), or any other video compression standard), raw images such as originating from Red Clear Blue (RCCB), Red Clear (RCCC) or other type of imaging sensor. In some examples, different formats and/or resolutions could be used for training the machine learning model(s) 104 than for inferencing (e.g., during deployment of the machine learning model(s) 104 in the vehicle 1000).

A sensor data or image data pre-processor may use data representative of one or more images (or other data representations, such as LiDAR depth maps) and load the sensor data 114 into memory in the form of a multi-dimensional array/matrix (alternatively referred to as tensor, or more specifically an input tensor, in some examples). The array size may be computed and/or represented as W×H×C, where W stands for the image width in pixels, H stands for the height in pixels, and C stands for the number of color channels. Without loss of generality, other types and orderings of input image components are also possible. In some embodiments, batching may be used for training and/or for inference. In such examples, the batch size B may be used as a dimension (e.g., an additional fourth dimension). Thus, the input tensor may represent an array of dimension W×H×C×B. Any ordering of the dimensions may be possible, which may depend on the particular hardware and software used to implement the sensor data or image data pre-processor. This ordering may be chosen to maximize training and/or inference performance of the machine learning model(s) 104.

In some embodiments, a pre-processing image pipeline may be employed by the sensor data or image data pre-processor to process a raw image(s) acquired by the sensor(s) 102 (e.g., camera(s)) and included in the sensor data 114 to produce pre-processed image data or sensor data which may represent an input image(s) to the input layer(s) (e.g., backbone 106 and/or feature extraction layers) of the machine learning model(s) 104. An example of a suitable pre-processing image pipeline may use a raw RCCB Bayer (e.g., 1-channel) type of image from the sensor and convert that image to a RCB (e.g., 3-channel) planar image stored in Fixed Precision (e.g., 16-bit-per-channel) format. The pre-processing image pipeline may include decompanding, noise reduction, demosaicing, white balancing, histogram computing, and/or adaptive global tone mapping (e.g., in that order, or in an alternative order).

Where noise reduction is employed by the image data pre-processor, it may include bilateral denoising in the Bayer domain. Where demosaicing is employed by the image data pre-processor, it may include bilinear interpolation. Where histogram computing is employed by the sensor data or image data pre-processor, it may involve computing a histogram for the C channel, and may be merged with the decompanding or noise reduction in some examples. Where adaptive global tone mapping is employed by the sensor data or image data pre-processor, it may include performing an adaptive gamma-log transform. This may include calculating a histogram, getting a mid-tone level, and/or estimating a maximum luminance with the mid-tone level.

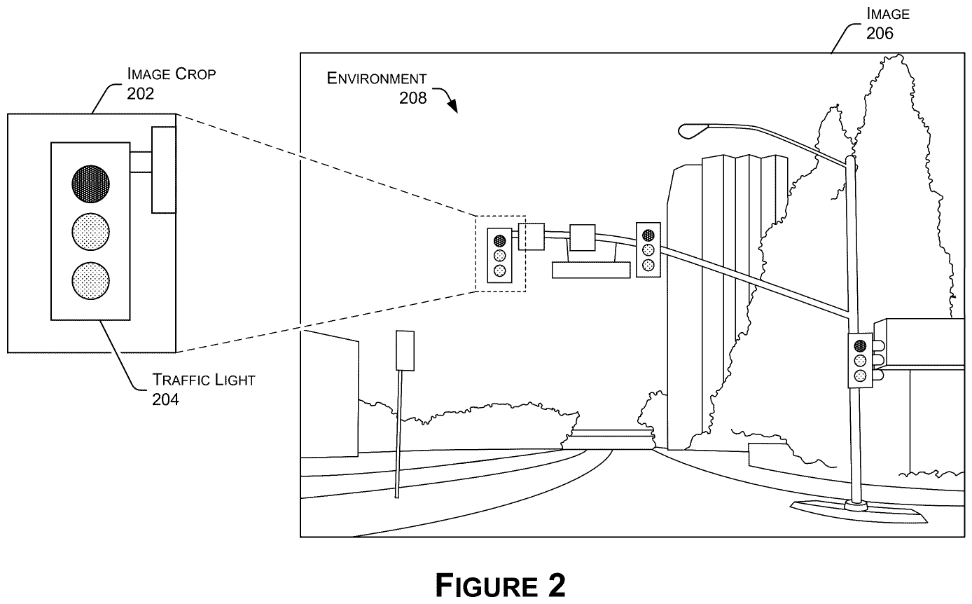

In some examples, the sensor data or image data pre-processor may generate an image crop of a traffic light from a larger image. For instance, FIG. 2 is an illustration of an image crop 202 depicting a traffic light 204, the image crop 202 obtained from image data representing an image 206 of an environment 208, in accordance with some embodiments of the present disclosure. In some instances, the sensor data or image data pre-processor may perform object detection or matching to identify and localize the traffic lights 204 within the image 206. That is, the sensor data or image data pre-processor may determine which pixels in the image 206 correspond to the traffic light 204 and/or a buffer area around the traffic light 204 as illustrated in the image crop 202. The sensor data or image data pre-processor may then generate the image crop 202 based on identifying those pixels, or otherwise localizing the traffic light 204 within the image 206.

As described herein, the sensor data 114 (e.g., the image crop 202, the preprocessed sensor data or image data, etc.) may be applied as input to the machine learning model(s) 104. In some examples, the machine learning model(s) 104 may include one or more deep neural networks (DNNs). Although examples are described herein with respect to using neural networks, and specifically DNNs as the machine learning model(s) 104, this is not intended to be limiting. For example, and without limitation, the machine learning model(s) 104 may include any type of machine learning model, such as a machine learning model(s) using linear regression, logistic regression, decision trees, support vector machines (SVM), Naïve Bayes, k-nearest neighbor (Knn), K means clustering, random forest, dimensionality reduction algorithms, gradient boosting algorithms, neural networks (e.g., auto-encoders, convolutional, recurrent, perceptrons, Long/Short Term Memory (LSTM), Hopfield, Boltzmann, deep belief, deconvolutional, generative adversarial, liquid state machine, etc.), and/or other types of machine learning models.

As shown in the example of FIG. 1, in some instances, the machine learning model(s) 104 may include a multi-component architecture. That is, the machine learning model(s) 104 may include a common backbone 106 and a plurality of component heads 108. The backbone 106 may serve as the machine learning model(s) 104 foundational architecture. For instance, the backbone 106 may include a series of layers and/or components that process the input data to extract meaningful features. In some examples, the backbone 106 may include one or more trained neural networks that have been optimized for tasks such as image classification or feature extraction. The backbone 106 may transform raw data into a higher-dimensional representation, capturing essential patterns and structures that facilitate the ability of the machine learning model(s) 104 to learn and make predictions. By leveraging the learned features from the backbone 106, additional layers of the machine learning model(s) 104—such as the component heads 108 and/or any other layers or components—may then fine-tune the model(s) 104 for specific tasks, improving accuracy and performance.

In various examples, each one of the component heads 108(1)-108(N) (where N may represent any number of component heads) may be trained or optimized to detect one or more attributes of one or more traffic lights depicted in an input. For instance, the first component head 108(1) of the machine learning model(s) 104 may be trained to predict one or more first attributes of the traffic light(s) (e.g., an orientation(s) of the traffic light(s)), a second component head (not shown) of the machine learning model(s) 104 may be trained to predict one or more second attributes of the traffic light(s) (e.g., housing shape(s)), an Nth component head 108(N) of the machine learning model(s) 104 may be trained to predict one or more Nth attributes of the traffic light (e.g., active bulb color(s) and/or shape(s)), and so forth. In various examples, a single component head may have more than one valid output for a given input. As an example, a component head that is to predict active bulb shapes may output an indication that the active bulbs of a traffic light include a round bulb and an arrow bulb when the round bulb and arrow bulb of the traffic light are illuminated at the same time (e.g., a green circle and a green left arrow).

In various examples, the machine learning model(s) 104 may use the component heads 108 to output the traffic light attribute(s) 116 associated with the traffic light device from the input. For instance, each one of the component heads 108 may generate a respective probability vector for the attribute(s) each component head is trained to detect. As an example, if the first component head 108(1) is trained to detect active bulb color attributes, then the first component head 108(1) may generate a probability vector that includes entries indicating the probability or confidence of the active bulb color(s) for the traffic light. For example, if the active bulb color of the traffic light is green, then the entries in the probability vector for the active bulb color being red or yellow may be a low value (e.g., 1%), while the entry for the active bulb color being green may be a higher value (e.g., 98%).

In some examples, the traffic light attribute(s) 116 may include, but are not limited to, orientation, housing shape, active bulb color, active bulb shape, bulb count, occlusion (e.g., whether the light is occluded by other objects), truncation (e.g., where the light is truncated by the image border), road user (e.g., which type(s) of road user(s) the traffic light applies to), and/or blinking state. For instance, the orientation of the traffic light may include one or more of whether the traffic light is front facing, non-front facing, back, left, right, unknown, etc. As another example, the housing shape may be vertical, horizontal, doghouse, pedestrian hybrid beacon, unknown, etc. Active bulb colors may include red, yellow, green, white, orange, unknown, or any other color. Active bulb shapes may include, in some instances, a circle, arrow straight, arrow left, arrow right, arrow down, arrow U-turn, bus, digit (e.g., countdown timer), tram, train, bike, pedestrian, hand, unknown, or any other shape. While these are just a few examples of attributes, this is not intended to be limiting, and the traffic light attribute(s) 116 may include any other attributes in additional or alternative examples.

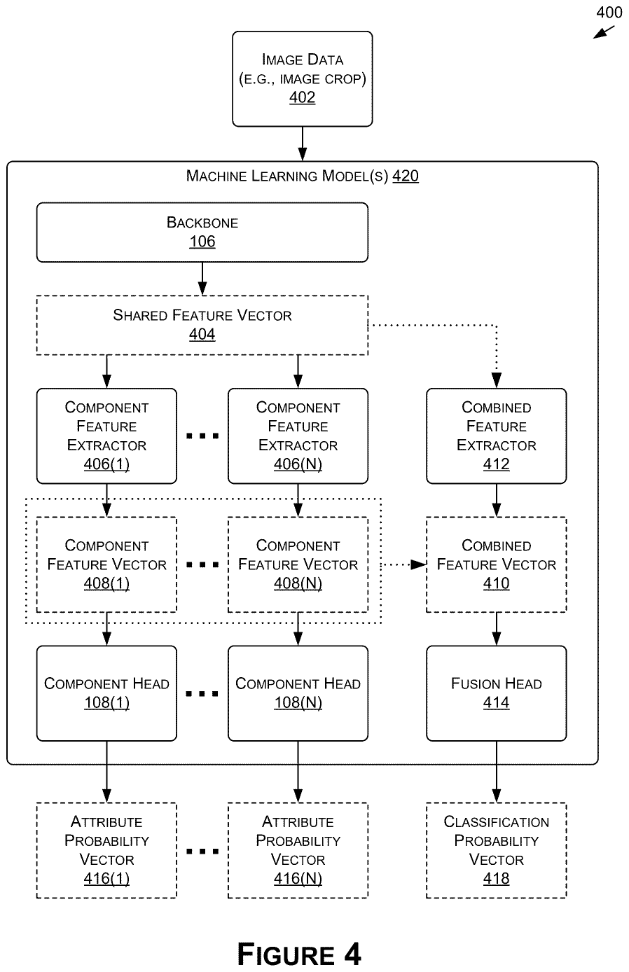

In some examples, the classifier 110 may use the traffic light attribute(s) 116 and/or other input data (not shown) to generate the traffic light classification(s) 118. Although shown in the example of FIG. 1 as being a separate component from the machine learning model(s) 104, in some examples the classifier 110 may be a component of the machine learning model(s) 104. For instance, the classifier 110 may correspond to the fusion head 414 of the machine learning model(s) 104 in the example of FIG. 4 described herein. In some examples, the classifier 110 may predict the traffic light classification(s) 118 based at least on one or more of the traffic light attribute(s) 116. For instance, if the traffic light attributes indicate that the traffic light housing is vertical, the total bulb count is three, and that the active bulb color is green, the classifier 110 may classify the traffic light as a green light. In some examples, the traffic light classification(s) 118 may include a combination of one or more of the detected traffic light attribute(s) 116. For instance, the traffic light classification(s) 118 may include or indicate a summary of the most important attributes of the traffic light that relate to the current state of the traffic light and/or the traffic rules being conveyed by the traffic light.

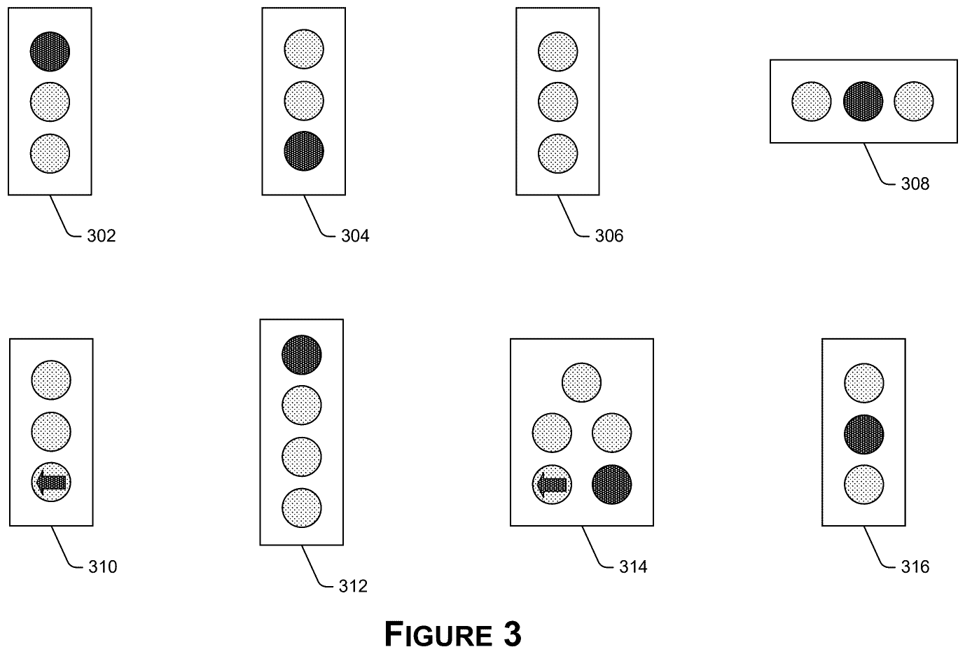

For instance, FIG. 3 illustrates various examples of traffic light configurations and states that may be classified using a multi-component machine learning model, in accordance with some embodiments of the present disclosure. Each of the traffic lights 302-316 shown in the example of FIG. 3 represent different states of traffic light devices that may be encountered in an environment and classified using the techniques of the present disclosure.

For instance, the traffic light 302 illustrates a vertical housing traffic light that is front facing, has a total bulb count of three, is not occluded or truncated, and has an active bulb color of red in the shape of a circle. In such an example, the traffic light attribute(s) 116 may indicate the traffic light 302 has a vertical housing, is front facing, bulb count equals three, and active bulb color and shape is a red circle. Additionally, the traffic light classification(s) 118 may indicate the class of the traffic light 302 is a red circle. In contrast, the traffic light 304 illustrates a vertical housing traffic light that is front facing, has a total bulb count of three, is not occluded or truncated, and has an active bulb color of green in the shape of a circle. In such an example, the traffic light attribute(s) 116 may indicate the traffic light 304 has a vertical housing, is front facing, bulb count equals three, and active bulb color and shape is a green circle. Additionally, the traffic light classification(s) 118 may indicate the class of the traffic light 304 is at least a green circle.

The traffic light 306 illustrates a vertical housing traffic light that is front facing, has a total bulb count of three, is not occluded or truncated, and is stateless (e.g., no active bulbs). For the traffic light 306, the traffic light attribute(s) 116 may indicate the traffic light 306 has a vertical housing, is front facing, bulb count equals three, and is stateless or unknown. Additionally, the traffic light classification(s) 118 may indicate the class of the traffic light 306 is stateless. The traffic light 308 includes a horizontal housing, is front facing, has a total bulb count of three, is not occluded or truncated, and has an active bulb color of yellow in the shape of a circle. In such an example, the traffic light attribute(s) 116 may indicate the traffic light 308 has a horizontal housing, is front facing, bulb count equals three, and active bulb color and shape is a yellow circle. Additionally, the traffic light classification(s) 118 may indicate the class of the traffic light 308 is at least a yellow circle.

The traffic light 310 illustrates a vertical housing traffic light that is front facing, has a total bulb count of three, is not occluded or truncated, and has an active bulb color of green in the shape of a left arrow. For the traffic light 310, the traffic light attribute(s) 116 may indicate the traffic light 310 has a vertical housing, is front facing, bulb count equals three, and has a green left arrow for its active bulb color-shape attribute. Additionally, the traffic light classification(s) 118 may indicate the class of the traffic light 310 is a green left arrow. The traffic light 312 illustrates a vertical housing traffic light that is front facing, has a total bulb count of four, is not occluded or truncated, and has an active bulb color of red in the shape of a circle. For the traffic light 312, the traffic light attribute(s) 116 may indicate the traffic light 312 has a vertical housing, is front facing, bulb count equals four, and has a red circle for its active bulb color-shape attribute. Additionally, the traffic light classification(s) 118 may indicate the class of the traffic light 312 is at least a red circle.

The traffic light 314 illustrates a doghouse traffic light that is front facing, has a total bulb count of five, is not occluded or truncated, and has active bulb colors and shapes of green left arrow and a green circle. For the traffic light 314, the traffic light attribute(s) 116 may indicate the traffic light 314 has a doghouse housing, is front facing, bulb count equals five, and has a green left arrow and green circle for its active bulb color-shape attributes. Additionally, the traffic light classification(s) 118 may indicate the class of the traffic light 314 is a green left arrow and green circle. Lastly, the traffic light 316 illustrates a vertical traffic light that is front facing, has a total bulb count of three, is not occluded or truncated, and has active bulb color of yellow in the shape of a circle. For the traffic light 316, the traffic light attribute(s) 116 may indicate the traffic light 316 has a vertical housing, is front facing, bulb count equals three, and has a yellow circle for its active bulb color-shape attributes. Additionally, the traffic light classification(s) 118 may indicate the class of the traffic light 316 is a yellow circle.

Referring back to the example of FIG. 1, the traffic light attribute(s) 116 and/or the traffic light classification(s) 118 may be forwarded to the drive stack component(s) 112. In some examples, the drive stack component(s) 112 may cause a machine (e.g., the vehicle 1000) to perform one or more operations based at least on the traffic light attribute(s) 116 and/or the traffic light classification(s) 118. For instance, the drive stack component(s) 112 may use the traffic light attribute(s) 116 and/or the traffic light classification(s) 118 to determine the active traffic rules for a current lane segment the machine is operating in. Based on the traffic rules, the drive stack component(s) 112 may cause the machine to perform one or more operations in accordance with the traffic rules (e.g., stop, go, turn, yield, etc.).

In various examples, the drive stack component(s) 112 may include a perception component, a model component, a planning component, a control component, an avoidance component, an actuation component, a wait perceiver, and/or other components corresponding to additional and/or alternative layers of the drive stack. These components may use, the traffic light attribute(s) 116 and/or the traffic light classification(s) 118 as inputs to make various decisions related to control operations on behalf of the machine.

In some examples, one or more of the drive stack component(s) 112 may aid the machine in avoiding collisions with objects (e.g., dynamic and stationary objects) and/or avoiding violations of traffic rules. For instance, one or more of the drive stack component(s) 112 may use the traffic light attribute(s) 116 and/or the traffic light classification(s) 118 to determine whether the intended behavior or path of the machine would violate traffic rules (e.g., run a red light, stop at a green light, turn when a signal traffic turn signal is required, etc.). Additionally, in some examples, one or more of the drive stack component(s) 112 may use the traffic light attribute(s) 116 and/or the traffic light classification(s) 118 to determine when to cause the machine to drive through an intersection, when to stop at the intersection, when the machine has a right of way, etc.

Referring now to FIG. 4, FIG. 4 is a data flow diagram illustrating an example of a process 400 for using a multi-component machine learning model architecture to predict attributes and/or classifications of traffic lights from image data, in accordance with some embodiments of the present disclosure. As shown, the image data 402—which may correspond to one or more of the sensor data 114, the image crop 202, and/or the image 206—may be applied to the machine learning model(s) 420. In some examples, the machine learning model(s) 420 may be similar to or the same as the machine learning model(s) 104 in the example of FIG. 1. For instance, the machine learning model(s) 420 may include a multi-component deep neural network.

As shown, the machine learning model(s) 420 may include the common backbone 106. Based on the input image data 402, the backbone 106 may generate a shared feature vector 404. The shared feature vector 404 may include a numerical representation that captures one or more essential characteristics or patterns of an image represented using the image data 402. In some instances, the shared feature vector 404 may be composed of multiple values, each representing a specific feature, such as color, texture, edges, or shapes present in the image, or a combination of any of these features. For example, the backbone 106 may generate the shared feature vector 404 to project the image's complex information into either a lower-dimensional space or a higher-dimensional space.

The shared feature vector 404 may be applied as inputs to a plurality of component feature extractors 406(1)-406(N). The component feature extractors 406(1)-406(N) may analyze the shared feature vector 404 to generate respective component feature vectors 408(1)-408(N), which may each be applied individually to the different component heads 108(1)-108(N). For instance, a first component feature vector 408(1) may be applied to the first component head 108(1), a second component feature vector (not shown) may be applied to a second component head (not shown) of the model(s) 420, an Nth component feature vector 408(N) may be applied to an Nth component head 108(N) of the model(s) 420, and so forth. In such examples, the features included in the component feature vectors 408 may allow the component heads 108 to make accurate predictions. In other words, the component feature vectors 408 may include selected features from the shared feature vector 404 that are usable by the component heads 108 to predict the attributes they are each trained to identify, while excluding features from the shared feature vector 404 that are not usable by the component heads 108. For example, a component feature vector that is applied to a component head for predicting traffic light orientation may exclude features relating to active bulb colors, and vice-versa. In some examples, the shared feature vector 404 may be applied as input to a combined feature extractor 412, which may generate a combined feature vector 410. Additionally, or alternatively, the combined feature vector 410 may be generated from the different component feature vectors 408(1)-408(N).

Using the component feature vectors 408(1)-408(N), the component heads 108(1)-108(N) may generate respective attribute probability vectors 416(1)-416(N). Similarly, using the combined feature vector 410, the fusion head 414 may generate a classification probability vector 418. These probability vectors may include multiple probability scores (e.g., confidence scores) for multiple attributes and/or classifications. For instance, entries in the probability vectors may include values indicating the probability of a certain traffic light having certain attributes and/or being of a certain class.

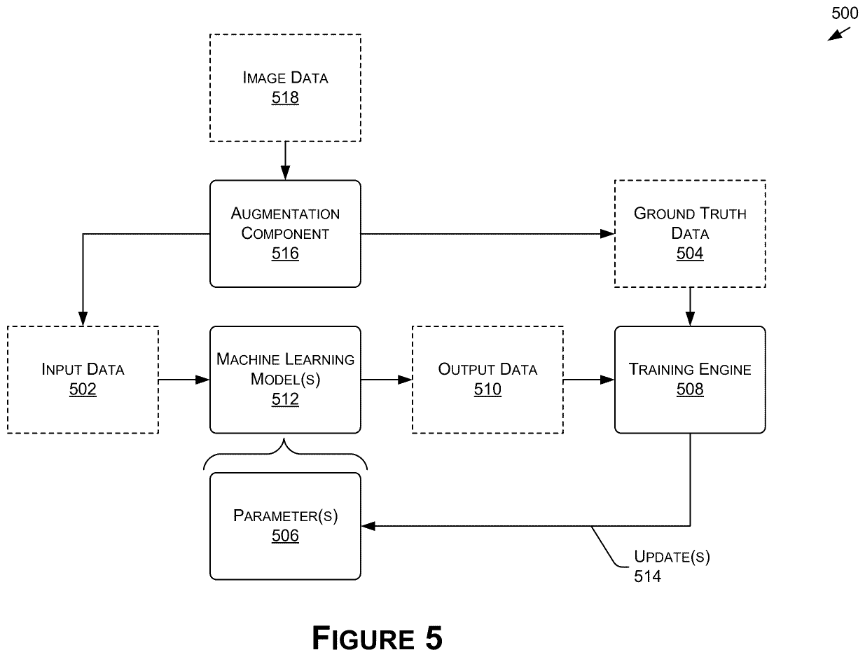

Referring now to FIG. 5, FIG. 5 is a data flow diagram illustrating an example process 500 for training one or more machine learning models 512 to predict traffic light classes and/or attributes, in accordance with some embodiments of the present disclosure. As shown, the machine learning model(s) 512 (which may correspond to the machine learning model(s) 104 and/or 420) may be trained using input data 502 (e.g., training inputs). The input data 502 may comprise images depicting traffic lights. In some examples, the images of the input data 502 may be generated using an augmentation component 516 to modify image data 518.

For instance, the augmentation component 516 may employ classical image processing methods, style transfer methods, or any other methods to perform data augmentation with respect to the image data 518. As an example, the augmentation component 516 may perform data augmentation to generate training samples of stateless lights by using image processing techniques to turn the red/green/yellow lights off. That is, the augmentation component 516 may identify the pixels in the image data 518 which have strong red/green/yellow color and intensity, and then modify those pixels to make them look similar to surrounding pixels. For example, for a red light, the augmentation component 516 may use a threshold in Hue, Saturation, and Value (HSV) color space to detect the pixels with higher red values and brightness, and then change the saturation to small value and brightness to be similar to surrounding pixels. In another example, the augmentation component 516 may perform grayscale augmentation to turn an image into a grayscale image so that no color information may be available. Using such techniques, the training engine 508 may train the machine learning model(s) 512 (e.g., neural network) to learn the concept of colors.

Additionally, or alternatively, the augmentation component 516 may use style transfer augmentation and the training engine 508 may train the machine learning model(s) 512 to learn the mapping between red/green/yellow lights to gray/stateless lights, or use a style transfer augmentation neural network to turn any traffic lights to green. As another example, the augmentation component 516 may use style transfer augmentation to change the shape and/or other properties of the light bulbs represented in the image data 518. For example, the augmentation component 516 may change the shape of a traffic light bulb(s) from one shape to another shape, such as from a circle to a left arrow, for instance. Additionally, these techniques may be applied to change other properties of a traffic light as well, such as number of light bulbs, housing shapes, orientation, etc.

The machine learning model(s) 512 may be trained using the training input data 502 as well as corresponding ground truth data 504 (which may also be generated by the augmentation component 516). In some examples, the ground truth data 504 may include various data indicating valid traffic light device attributes or classes, including annotations, labels, masks, values (e.g., confidence values) and/or the like. For example, in some embodiments, the ground truth data 504 may indicate actual confidence values associated with traffic signal device attributes and/or traffic signal device classes from the input data 502.

The input data 502 and ground truth data 504 may be included as part of a training dataset generated using the augmentation component 516. Additionally, in any example, the ground truth data 504 may be synthetically produced (e.g., generated from computer models or renderings), real produced (e.g., designed and produced from real-world data), machine-automated (e.g., using feature analysis and learning to extract features from data and then generate labels), human annotated (e.g., labeler, or annotation expert, defines the location of the labels), and/or a combination thereof.

The training engine 508 may use one or more loss functions that measure loss (e.g., error) in the output data 510 generated by the machine learning model(s) 512 as compared to the ground truth data 504 and/or the input data 502. In some examples, the training engine 508 may compare the output data 510 from the machine learning model(s) 512 to the input data 502, and update 514 one or more parameters 506 of the machine learning model(s) 512 based at least on the comparing. That is, the training engine 508 may update/optimize one or more parameters 506 associated with the machine learning model(s) 512 to reduce the losses/differences between the output data 510 (e.g., predicted traffic light attributes or classes) and the ground truth data 504 (e.g., ground truth traffic light attributes or classes). Any type of loss function may be used, such as cross entropy loss, mean squared error, mean absolute error, mean bias error, and/or other loss function types. In some examples, different outputs may have different loss functions. In such examples, the loss functions may be combined to form a total loss, and the total loss may be used to train (e.g., update the parameters of) the machine learning model(s) 512. In any example, backward pass computations may be performed to recursively compute gradients of the loss function(s) with respect to training parameters. In some examples, weight and biases of the machine learning model(s) 512 may be used to compute these gradients.

In some examples, in order to reduce false positive activations in each component head (e.g., the component heads 108) and/or in the fusion head (e.g., the classifier 110 and/or the fusion head 414), the system(s) of the present disclosure may apply implicit negative training targets for each negative sample, and the training engine 508 may map negative samples to a uniform distribution output. In this way, the machine learning model(s) 512 may better distinguish valid samples from unknown or invalid samples.

In some instances, when a component head (e.g., orientation) is allowed to have only one valid output, the training engine 508 may train the machine learning model(s) 512 to apply softmax activation. For instance, the implicit negative training target for a negative sample may be an above-zero uniform distribution. The sum of the uniform distribution may not necessarily sum up to one, but may need to be smaller than the confidence threshold to be applied at test time. In this way, the confidence threshold applied at test time may determine whether a test sample is a negative sample or a positive sample. If the maximum activation across all classes is below the threshold, then the sample may be a negative sample for that component or fusion head. Otherwise, the sample may be a positive sample for that component or fusion head, and the maximum activation across all classes may become the predicted class. In some examples, cross-entropy loss or any other single-label loss function (e.g., focal loss), labeling smoothing, and/or any other regularization method may be applied during training.

On the other hand, when a component head (e.g., color-shape) is allowed to have more than one valid output, the training engine 508 may train the machine learning model(s) 512 to apply sigmoid activation. For instance, the implicit negative training target for a negative sample may be an all-zero uniform distribution. If the maximum activation across all classes is below the confidence threshold applied at test time, then the sample may a negative sample for that component or fusion head. Otherwise, the sample may be a positive sample for that component or fusion head, and any class with a probability at or above the confidence threshold may become one predicted class. In some examples, binary cross-entropy loss or any other multi-label loss function (e.g., binary focal loss), labeling smoothing, and any other regularization methods may be applied during training.

In some examples, the machine learning model(s) 512 may be packaged as a microservice—such an inference microservice (e.g., NVIDIA NIMs)—which may include a container (e.g., an operating system (OS)-level virtualization package) that may include an application programming interface (API) layer, a server layer, a runtime layer, and/or a model “engine.” For example, the inference microservice may include the container itself and the model (e.g., weights and biases). In some instances, such as where the machine learning model(s) 512 is small enough (e.g., has a small enough number of parameters), the model(s) 512 may be included within the container itself. In some embodiments, the machine learning model(s) 512 described herein may be deployed as an inference microservice to accelerate deployment of models on any cloud, data center, or edge computing system, while ensuring the data is secure. For example, the inference microservice may include one or more APIs, a pre-configured container for simplified deployment, an optimized inference engine (e.g., built using a standardized AI model deployment an execution software, such as NVIDIA's Triton Inference Server, and/or one or more APIs for high performance deep learning inference, which may include an inference runtime and model optimizations that deliver low latency and high throughput for production applications - such as NVIDIA's TensorRT), and/or enterprise management data for telemetry (e.g., including identity, metrics, health checks, and/or monitoring). The machine learning model(s) 512 described herein may be included as part of the microservice along with an accelerated infrastructure with the ability to deploy with a single command and/or orchestrate and auto-scale with a container orchestration system on accelerated infrastructure (e.g., on a single device up to data center scale). As such, the inference microservice may include the machine learning model(s) 512 (e.g., that has been optimized for high performance inference), an inference runtime software to execute the machine learning model(s) 512 and provide outputs/responses to inputs (e.g., user queries, prompts, etc.), and enterprise management software to provide health checks, identity, and other monitoring. In some embodiments, the inference microservice may include software to perform in-place replacement and/or updating to the machine learning model(s) 512. When replacing or updating, the software that performs the replacement/updating may maintain user configurations of the inference runtime software and enterprise management software.

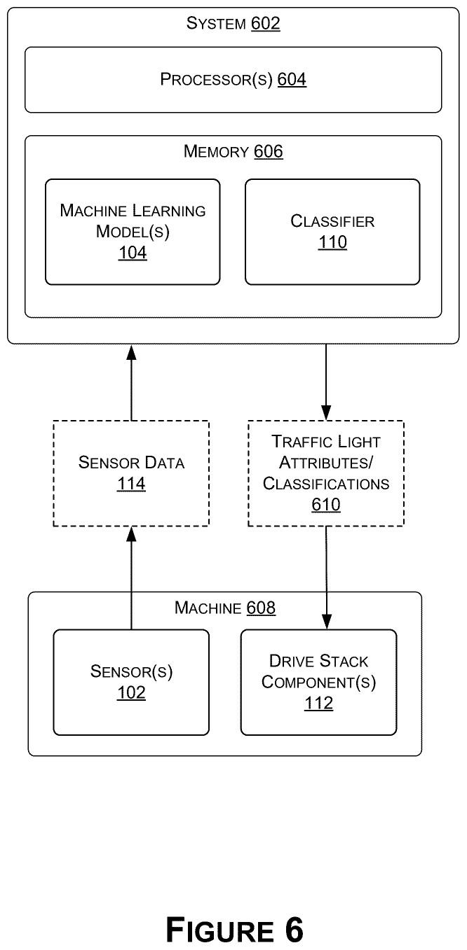

FIG. 6 illustrates an example of a system that may perform one or more of the processes described herein, in accordance with some embodiments of the present disclosure. As shown, the system 602 (which may represent, and/or include, the example computing device(s) 1100 and/or the example data center 1200) may include one or more processors 604 (which may be similar to, and/or include, the CPUs 1106 and/or the GPUs 1108) and memory 606 (which may be similar to, and/or include, the memory 1104). For instance, the memory 606 may store one or more of the machine learning model(s) 104 and/or the classifier 110. Additionally, the processor(s) 604 may execute one or more of the machine learning model(s) 104 and/or the classifier 110 to perform one or more of the processes described herein.

For instance, the system 602 may receive sensor data 114 from the sensor(s) 102 of a machine 608 (which may correspond to the vehicle 1000). The sensor data 114 may be applied to the machine learning model(s) 104 and the machine learning model(s) 104 may predict one or more attributes associated with one or more traffic lights represented in the sensor data 114. The classifier 110 may use the traffic light attribute(s) to determine one or more classifications of the traffic light(s). The traffic light attributes/classifications 610 may then be sent to the drive stack component(s) 112 of the machine 608. The drive stack component(s) 112 may cause the machine 608 to perform one or more control operations based on the traffic light attributes/classifications 610.

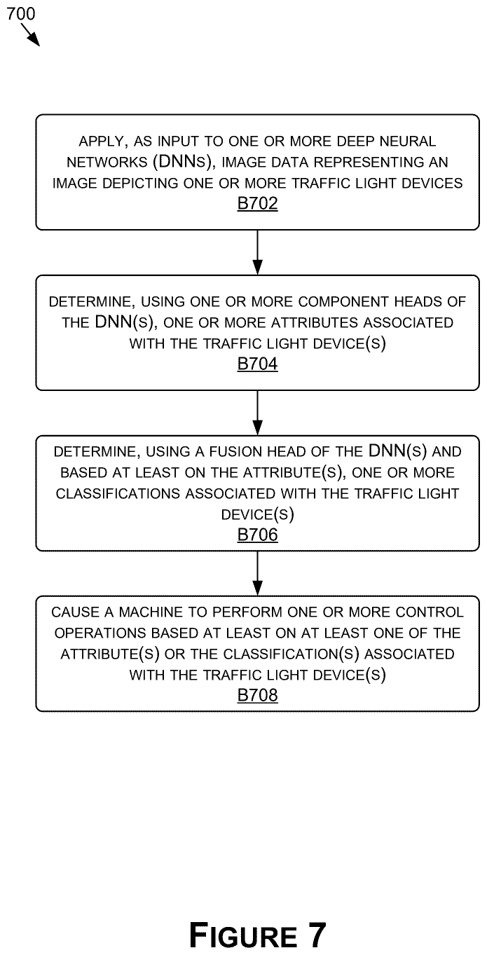

Now referring to FIGS. 7-9, each block of methods 700, 800, and 900, described herein, comprises a computing process that may be performed using any combination of hardware, firmware, and/or software. For instance, various functions may be carried out by a processor executing instructions stored in memory. The methods may also be embodied as computer-usable instructions stored on computer storage media. The methods may be provided by a standalone application, a service or hosted service (standalone or in combination with another hosted service), or a plug-in to another product, to name a few. In addition, methods 700, 800, and 900 may be described, by way of example, with respect to FIG. 1. However, these methods may additionally or alternatively be executed by any one system, or any combination of systems, including, but not limited to, those described herein.

FIG. 7 is a flow diagram illustrating an example of a method 700 for traffic light classification, in accordance with some embodiments of the present disclosure. The method 700, at block B702, includes applying, as input to one or more deep neural networks (DNNs), image data representing an image depicting one or more traffic light devices. For instance, the image data 402 may be applied as the input to the machine learning model(s) 420, which may be one or more DNNs. The image data 402 may represent an image (e.g., image crop) depicting the traffic light device(s).

The method 700, at block B704, includes determining, using one or more component heads of the DNN(s), one or more attributes associated with the traffic light device(s). For instance, the component heads 108(1)-108(N) may be used to determine or generate the attribute probability vectors 416(1)-416(N), respectively. The attribute probability vectors 416 may be indicative of the detected attributes associated with the traffic light device(s).

The method 700, at block B706, includes determine, using a fusion head of the DNN(s) and based at least on the attribute(s), one or more classifications associated with the traffic light device(s). For instance, the fusion head 414 of the machine learning model(s) 420 may be used to determine the classification probability vector 418, which may be indicative of the classification(s) associated with the traffic light device(s). In some examples, the fusion head 414 may determine the classifications based on the combined feature vector 410, based on embeddings, and/or based on the attributes predicted by the component heads 108.

The method 700, at block B708, includes causing a machine to perform one or more control operations based at least on at least one of the attribute(s) or the classification(s) associated with the traffic light device(s). For instance, the drive stack component(s) 112 may cause the machine (e.g., vehicle 1000) to perform the control operation(s) based at least on the attribute(s) (e.g., traffic light attribute(s) 116 and/or attribute probability vectors 416) or the classification(s) (e.g., traffic light classification(s) 118 and/or classification probability vector 418) associated with the traffic light device(s).

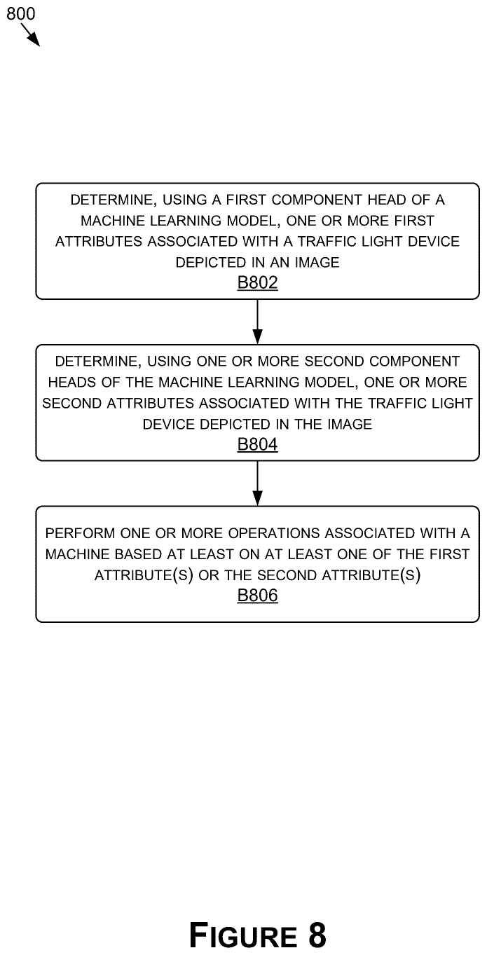

FIG. 8 is a flow diagram illustrating an example of a method 800 for determining traffic light attributes using a multi-component machine learning model, in accordance with some embodiments of the present disclosure. The method 800, at block B802, includes determining, using a first component head of a machine learning model, one or more first attributes associated with a traffic light device depicted in an image. For instance, the machine learning model(s) 104 may use the first component head 108(1) to determine the first attribute(s) associated with the traffic light device.

The method 800, at block B804, includes determining, using one or more second component heads of the machine learning model, one or more second attributes associated with the traffic light device depicted in the image. For instance, the machine learning model(s) 104 may use the Nth component head 108(N) to determine the second attribute(s) associated with the traffic light device. In some examples, the second attribute(s) may be different from the first attribute(s). For instance, the first attribute(s) may include a housing shape of the traffic light and the second attributes may include a color(s) and a shape(s) of an active bulb(s) of the traffic light.

The method 800, at block B806, includes performing one or more operations associated with a machine based at least on at least one of the first attribute(s) or the second attribute(s). For instance, the drive stack component(s) 112 may cause the machine (e.g., vehicle 1000) to perform the operation(s) based at least on at least one of the first attribute(s) or the second attribute(s). In some instances, the operation(s) may include, but is not limited to, stopping the machine, accelerating the machine, adjusting a steering angle of the machine, determining whether a current operation of the machine violates one or more traffic rules, determining active traffic rules based on the attributes, etc.

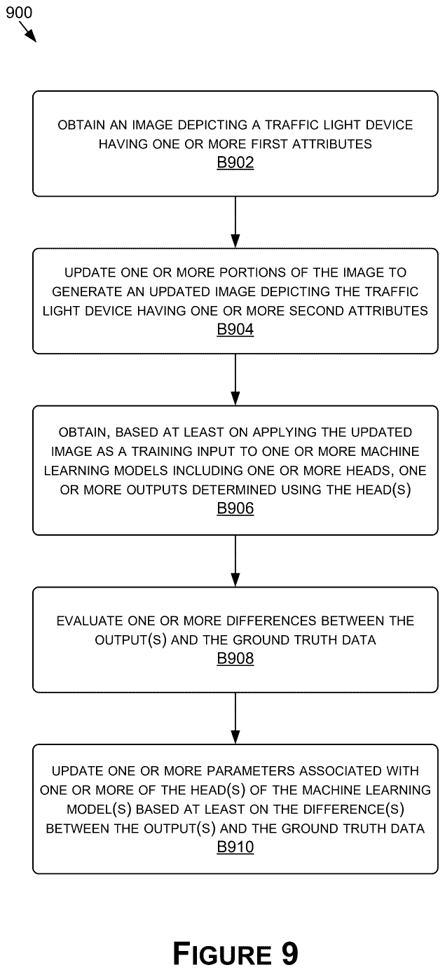

FIG. 9 is a flow diagram illustrating an example of a method 900 for training a multi-component machine learning model to predict traffic light attributes and/or classes, in accordance with some embodiments of the present disclosure. The method 900, at block B902, includes obtaining an image depicting a traffic light device having one or more first attributes. For instance, the image may be an original image depicting an environment and/or the traffic light device in the environment. In some instances, the image may be captured using a camera of a machine that is operating in the environment.

The method 900, at block B904, includes updating one or more portions of the image to generate an updated image depicting the traffic light device having one or more second attributes. For instance, the augmentation component 516 may update the portion(s) of the image to generate the updated image depicting the traffic light device having the second attribute(s). In some examples, the second attribute(s) may be different from the first attribute(s). As a first example, in the original image the traffic light device may have an active red light bulb, and in the updated image the traffic light device may have an active green light bulb while the red light bulb may be inactive. Additionally, or alternatively, in the original image the traffic light device may have a vertical housing, and in the updated image the traffic light may have a horizontal or a doghouse housing. In any example, any number of different attributes of the traffic light may be updated or changed between the original image and the updated image.

The method 900, at block B906, includes obtaining, based at least on applying the updated image as a training input to one or more machine learning models including one or more heads, one or more outputs determined using the head(s). For instance, based at least on applying the updated image as the training input to the machine learning model(s) 512, the different component heads 108 may predict the attributes of the traffic light depicted in the updated image.

The method 900, at block B908, includes evaluating one or more differences between the output(s) and the ground truth data. For instance, the training engine 508 may evaluate the difference(s) between the output data 510 and the ground truth data 504. To do this, the training engine 508 may compare confidence values included in probability vectors with actual values from the ground truth. In some instances, to evaluate the difference(s), losses may be computed between the output data 510 and the ground truth data 504.

The method 900, at block B910, includes updating one or more parameters associated with one or more of the head(s) of the machine learning model(s) based at least on the difference(s) between the output(s) and the ground truth data. For instance, the training engine 508 may update the parameter(s) 506 of the machine learning model(s) 512 to reduce the difference(s) (e.g., losses) between the output data 510 and the ground truth data 504. In some examples, updating the parameters may include updating weights or biases of the model and/or one or more of the component heads.

The systems and methods described herein may be used for a variety of purposes, by way of example and without limitation, for machine control, machine locomotion, machine driving, synthetic data generation, model training, perception, augmented reality, virtual reality, mixed reality, robotics, security and surveillance, autonomous or semi-autonomous machine applications, deep learning, environment simulation, data center processing, conversational AI, light transport simulation (e.g., ray tracing, path tracing, etc.), collaborative content creation for 3D assets, cloud computing, generative AI, (large) language models, and/or any other suitable applications.

Disclosed embodiments may be comprised in a variety of different systems such as automotive systems (e.g., a control system for an autonomous or semi-autonomous machine, a perception system for an autonomous or semi-autonomous machine), systems implemented using a robot, aerial systems, medial systems, boating systems, smart area monitoring systems, systems for performing deep learning operations, systems for performing simulation operations, systems implemented using an edge device, systems incorporating one or more virtual machines (VMs), systems for performing synthetic data generation operations, systems implemented at least partially in a data center, systems for performing conversational AI operations, systems for performing light transport simulation, systems for performing collaborative content creation for 3D assets, systems implemented at least partially using cloud computing resources, systems for performing generative AI operations, systems implementing—or for performing operations using—a large language model (LLM), and/or other types of systems.

### Example Autonomous Vehicle

FIG. 10A is an illustration of an example autonomous vehicle 1000, in accordance with some embodiments of the present disclosure. The autonomous vehicle 1000 (alternatively referred to herein as the “vehicle 1000”) may include, without limitation, a passenger vehicle, such as a car, a truck, a bus, a first responder vehicle, a shuttle, an electric or motorized bicycle, a motorcycle, a fire truck, a police vehicle, an ambulance, a boat, a construction vehicle, an underwater craft, a robotic vehicle, a drone, an airplane, a vehicle coupled to a trailer (e.g., a semi-tractor-trailer truck used for hauling cargo), and/or another type of vehicle (e.g., that is unmanned and/or that accommodates one or more passengers). Autonomous vehicles are generally described in terms of automation levels, defined by the National Highway Traffic Safety Administration (NHTSA), a division of the US Department of Transportation, and the Society of Automotive Engineers (SAE) “Taxonomy and Definitions for Terms Related to Driving Automation Systems for On-Road Motor Vehicles” (Standard No. J3016-201806, published on Jun. 15, 2018, Standard No. J3016-201609, published on Sep. 30, 2016, and previous and future versions of this standard). The vehicle 1000 may be capable of functionality in accordance with one or more of Level 3-Level 5 of the autonomous driving levels. The vehicle 1000 may be capable of functionality in accordance with one or more of Level 1-Level 5 of the autonomous driving levels. For example, the vehicle 1000 may be capable of driver assistance (Level 1), partial automation (Level 2), conditional automation (Level 3), high automation (Level 4), and/or full automation (Level 5), depending on the embodiment. The term “autonomous,” as used herein, may include any and/or all types of autonomy for the vehicle 1000 or other machine, such as being fully autonomous, being highly autonomous, being conditionally autonomous, being partially autonomous, providing assistive autonomy, being semi-autonomous, being primarily autonomous, or other designation.

The vehicle 1000 may include components such as a chassis, a vehicle body, wheels (e.g., 2, 4, 6, 8, 18, etc.), tires, axles, and other components of a vehicle. The vehicle 1000 may include a propulsion system 1050, such as an internal combustion engine, hybrid electric power plant, an all-electric engine, and/or another propulsion system type. The propulsion system 1050 may be connected to a drive train of the vehicle 1000, which may include a transmission, to enable the propulsion of the vehicle 1000. The propulsion system 1050 may be controlled in response to receiving signals from the throttle/accelerator 1052.

A steering system 1054, which may include a steering wheel, may be used to steer the vehicle 1000 (e.g., along a desired path or route) when the propulsion system 1050 is operating (e.g., when the vehicle is in motion). The steering system 1054 may receive signals from a steering actuator 1056. The steering wheel may be optional for full automation (Level 5) functionality.

The brake sensor system 1046 may be used to operate the vehicle brakes in response to receiving signals from the brake actuators 1048 and/or brake sensors.

Controller(s) 1036, which may include one or more system on chips (SoCs) 1004 (FIG. 10C) and/or GPU(s), may provide signals (e.g., representative of commands) to one or more components and/or systems of the vehicle 1000. For example, the controller(s) may send signals to operate the vehicle brakes via one or more brake actuators 1048, to operate the steering system 1054 via one or more steering actuators 1056, to operate the propulsion system 1050 via one or more throttle/accelerators 1052. The controller(s) 1036 may include one or more onboard (e.g., integrated) computing devices (e.g., supercomputers) that process sensor signals, and output operation commands (e.g., signals representing commands) to enable autonomous driving and/or to assist a human driver in driving the vehicle 1000. The controller(s) 1036 may include a first controller 1036 for autonomous driving functions, a second controller 1036 for functional safety functions, a third controller 1036 for artificial intelligence functionality (e.g., computer vision), a fourth controller 1036 for infotainment functionality, a fifth controller 1036 for redundancy in emergency conditions, and/or other controllers. In some examples, a single controller 1036 may handle two or more of the above functionalities, two or more controllers 1036 may handle a single functionality, and/or any combination thereof.

The controller(s) 1036 may provide the signals for controlling one or more components and/or systems of the vehicle 1000 in response to sensor data received from one or more sensors (e.g., sensor inputs). The sensor data may be received from, for example and without limitation, global navigation satellite systems (“GNSS”) sensor(s) 1058 (e.g., Global Positioning System sensor(s)), RADAR sensor(s) 1060, ultrasonic sensor(s) 1062, LIDAR sensor(s) 1064, inertial measurement unit (IMU) sensor(s) 1066 (e.g., accelerometer(s), gyroscope(s), magnetic compass(es), magnetometer(s), etc.), microphone(s) 1096, stereo camera(s) 1068, wide-view camera(s) 1070 (e.g., fisheye cameras), infrared camera(s) 1072, surround camera(s) 1074 (e.g., 360 degree cameras), long-range and/or mid-range camera(s) 1098, speed sensor(s) 1044 (e.g., for measuring the speed of the vehicle 1000), vibration sensor(s) 1042, steering sensor(s) 1040, brake sensor(s) (e.g., as part of the brake sensor system 1046), and/or other sensor types.

One or more of the controller(s) 1036 may receive inputs (e.g., represented by input data) from an instrument cluster 1032 of the vehicle 1000 and provide outputs (e.g., represented by output data, display data, etc.) via a human-machine interface (HMI) display 1034, an audible annunciator, a loudspeaker, and/or via other components of the vehicle 1000. The outputs may include information such as vehicle velocity, speed, time, map data (e.g., the High Definition (“HD”) map 1022 of FIG. 10C), location data (e.g., the vehicle's 1000 location, such as on a map), direction, location of other vehicles (e.g., an occupancy grid), information about objects and status of objects as perceived by the controller(s) 1036, etc. For example, the HMI display 1034 may display information about the presence of one or more objects (e.g., a street sign, caution sign, traffic light changing, etc.), and/or information about driving maneuvers the vehicle has made, is making, or will make (e.g., changing lanes now, taking exit 34B in two miles, etc.).

The vehicle 1000 further includes a network interface 1024 which may use one or more wireless antenna(s) 1026 and/or modem(s) to communicate over one or more networks. For example, the network interface 1024 may be capable of communication over Long-Term Evolution (“LTE”), Wideband Code Division Multiple Access (“WCDMA”), Universal Mobile Telecommunications System (“UMTS”), Global System for Mobile communication (“GSM”), IMT-CDMA Multi-Carrier (“CDMA2000”), etc. The wireless antenna(s) 1026 may also enable communication between objects in the environment (e.g., vehicles, mobile devices, etc.), using local area network(s), such as Bluetooth, Bluetooth Low Energy (“LE”), Z-Wave, ZigBee, etc., and/or low power wide-area network(s) (“LPWANs”), such as LoRaWAN, SigFox, etc.

FIG. 10B is an example of camera locations and fields of view for the example autonomous vehicle 1000 of FIG. 10A, in accordance with some embodiments of the present disclosure. The cameras and respective fields of view are one example embodiment and are not intended to be limiting. For example, additional and/or alternative cameras may be included and/or the cameras may be located at different locations on the vehicle 1000.

The camera types for the cameras may include, but are not limited to, digital cameras that may be adapted for use with the components and/or systems of the vehicle 1000. The camera(s) may operate at automotive safety integrity level (ASIL) B and/or at another ASIL. The camera types may be capable of any image capture rate, such as 60 frames per second (fps), 120 fps, 240 fps, etc., depending on the embodiment. The cameras may be capable of using rolling shutters, global shutters, another type of shutter, or a combination thereof. In some examples, the color filter array may include a red clear clear clear (RCCC) color filter array, a red clear clear blue (RCCB) color filter array, a red blue green clear (RBGC) color filter array, a Foveon X3 color filter array, a Bayer sensors (RGGB) color filter array, a monochrome sensor color filter array, and/or another type of color filter array. In some embodiments, clear pixel cameras, such as cameras with an RCCC, an RCCB, and/or an RBGC color filter array, may be used in an effort to increase light sensitivity.

In some examples, one or more of the camera(s) may be used to perform advanced driver assistance systems (ADAS) functions (e.g., as part of a redundant or fail-safe design). For example, a Multi-Function Mono Camera may be installed to provide functions including lane departure warning, traffic sign assist and intelligent headlamp control. One or more of the camera(s) (e.g., all of the cameras) may record and provide image data (e.g., video) simultaneously.

One or more of the cameras may be mounted in a mounting assembly, such as a custom designed (three dimensional (“3D”) printed) assembly, in order to cut out stray light and reflections from within the car (e.g., reflections from the dashboard reflected in the windshield mirrors) which may interfere with the camera's image data capture abilities. With reference to wing-mirror mounting assemblies, the wing-mirror assemblies may be custom 3D printed so that the camera mounting plate matches the shape of the wing-mirror. In some examples, the camera(s) may be integrated into the wing-mirror. For side-view cameras, the camera(s) may also be integrated within the four pillars at each corner of the cabin.

Cameras with a field of view that include portions of the environment in front of the vehicle 1000 (e.g., front-facing cameras) may be used for surround view, to help identify forward facing paths and obstacles, as well aid in, with the help of one or more controllers 1036 and/or control SoCs, providing information critical to generating an occupancy grid and/or determining the preferred vehicle paths. Front-facing cameras may be used to perform many of the same ADAS functions as LIDAR, including emergency braking, pedestrian detection, and collision avoidance. Front-facing cameras may also be used for ADAS functions and systems including Lane Departure Warnings (“LDW”), Autonomous Cruise Control (“ACC”), and/or other functions such as traffic sign recognition.

A variety of cameras may be used in a front-facing configuration, including, for example, a monocular camera platform that includes a complementary metal oxide semiconductor (“CMOS”) color imager. Another example may be a wide-view camera(s) 1070 that may be used to perceive objects coming into view from the periphery (e.g., pedestrians, crossing traffic or bicycles). Although only one wide-view camera is illustrated in FIG. 10B, there may be any number (including zero) of wide-view cameras 1070 on the vehicle 1000. In addition, any number of long-range camera(s) 1098 (e.g., a long-view stereo camera pair) may be used for depth-based object detection, especially for objects for which a neural network has not yet been trained. The long-range camera(s) 1098 may also be used for object detection and classification, as well as basic object tracking.

Any number of stereo cameras 1068 may also be included in a front-facing configuration. In at least one embodiment, one or more of stereo camera(s) 1068 may include an integrated control unit comprising a scalable processing unit, which may provide a programmable logic (“FPGA”) and a multi-core micro-processor with an integrated Controller Area Network (“CAN”) or Ethernet interface on a single chip. Such a unit may be used to generate a 3D map of the vehicle's environment, including a distance estimate for all the points in the image. An alternative stereo camera(s) 1068 may include a compact stereo vision sensor(s) that may include two camera lenses (one each on the left and right) and an image processing chip that may measure the distance from the vehicle to the target object and use the generated information (e.g., metadata) to activate the autonomous emergency braking and lane departure warning functions. Other types of stereo camera(s) 1068 may be used in addition to, or alternatively from, those described herein.

Cameras with a field of view that include portions of the environment to the side of the vehicle 1000 (e.g., side-view cameras) may be used for surround view, providing information used to create and update the occupancy grid, as well as to generate side impact collision warnings. For example, surround camera(s) 1074 (e.g., four surround cameras 1074 as illustrated in FIG. 10B) may be positioned to on the vehicle 1000. The surround camera(s) 1074 may include wide-view camera(s) 1070, fisheye camera(s), 360 degree camera(s), and/or the like. Four example, four fisheye cameras may be positioned on the vehicle's front, rear, and sides. In an alternative arrangement, the vehicle may use three surround camera(s) 1074 (e.g., left, right, and rear), and may leverage one or more other camera(s) (e.g., a forward-facing camera) as a fourth surround view camera.

Cameras with a field of view that include portions of the environment to the rear of the vehicle 1000 (e.g., rear-view cameras) may be used for park assistance, surround view, rear collision warnings, and creating and updating the occupancy grid. A wide variety of cameras may be used including, but not limited to, cameras that are also suitable as a front-facing camera(s) (e.g., long-range and/or mid-range camera(s) 1098, stereo camera(s) 1068), infrared camera(s) 1072, etc.), as described herein.

FIG. 10C is a block diagram of an example system architecture for the example autonomous vehicle 1000 of FIG. 10A, in accordance with some embodiments of the present disclosure. It should be understood that this and other arrangements described herein are set forth only as examples. Other arrangements and elements (e.g., machines, interfaces, functions, orders, groupings of functions, etc.) may be used in addition to or instead of those shown, and some elements may be omitted altogether. Further, many of the elements described herein are functional entities that may be implemented as discrete or distributed components or in conjunction with other components, and in any suitable combination and location. Various functions described herein as being performed by entities may be carried out by hardware, firmware, and/or software. For instance, various functions may be carried out by a processor executing instructions stored in memory.

Each of the components, features, and systems of the vehicle 1000 in FIG. 10C are illustrated as being connected via bus 1002. The bus 1002 may include a Controller Area Network (CAN) data interface (alternatively referred to herein as a “CAN bus”). A CAN may be a network inside the vehicle 1000 used to aid in control of various features and functionality of the vehicle 1000, such as actuation of brakes, acceleration, braking, steering, windshield wipers, etc. A CAN bus may be configured to have dozens or even hundreds of nodes, each with its own unique identifier (e.g., a CAN ID). The CAN bus may be read to find steering wheel angle, ground speed, engine revolutions per minute (RPMs), button positions, and/or other vehicle status indicators. The CAN bus may be ASIL B compliant.

Although the bus 1002 is described herein as being a CAN bus, this is not intended to be limiting. For example, in addition to, or alternatively from, the CAN bus, FlexRay and/or Ethernet may be used. Additionally, although a single line is used to represent the bus 1002, this is not intended to be limiting. For example, there may be any number of busses 1002, which may include one or more CAN busses, one or more FlexRay busses, one or more Ethernet busses, and/or one or more other types of busses using a different protocol. In some examples, two or more busses 1002 may be used to perform different functions, and/or may be used for redundancy. For example, a first bus 1002 may be used for collision avoidance functionality and a second bus 1002 may be used for actuation control. In any example, each bus 1002 may communicate with any of the components of the vehicle 1000, and two or more busses 1002 may communicate with the same components. In some examples, each SoC 1004, each controller 1036, and/or each computer within the vehicle may have access to the same input data (e.g., inputs from sensors of the vehicle 1000), and may be connected to a common bus, such the CAN bus.

The vehicle 1000 may include one or more controller(s) 1036, such as those described herein with respect to FIG. 10A. The controller(s) 1036 may be used for a variety of functions. The controller(s) 1036 may be coupled to any of the various other components and systems of the vehicle 1000, and may be used for control of the vehicle 1000, artificial intelligence of the vehicle 1000, infotainment for the vehicle 1000, and/or the like.

The vehicle 1000 may include a system(s) on a chip (SoC) 1004. The SoC 1004 may include CPU(s) 1006, GPU(s) 1008, processor(s) 1010, cache(s) 1012, accelerator(s) 1014, data store(s) 1016, and/or other components and features not illustrated. The SoC(s) 1004 may be used to control the vehicle 1000 in a variety of platforms and systems. For example, the SoC(s) 1004 may be combined in a system (e.g., the system of the vehicle 1000) with an HD map 1022 which may obtain map refreshes and/or updates via a network interface 1024 from one or more servers (e.g., server(s) 1078 of FIG. 10D).

The CPU(s) 1006 may include a CPU cluster or CPU complex (alternatively referred to herein as a “CCPLEX”). The CPU(s) 1006 may include multiple cores and/or L2 caches. For example, in some embodiments, the CPU(s) 1006 may include eight cores in a coherent multi-processor configuration. In some embodiments, the CPU(s) 1006 may include four dual-core clusters where each cluster has a dedicated L2 cache (e.g., a 2 MB L2 cache). The CPU(s) 1006 (e.g., the CCPLEX) may be configured to support simultaneous cluster operation enabling any combination of the clusters of the CPU(s) 1006 to be active at any given time.

The CPU(s) 1006 may implement power management capabilities that include one or more of the following features: individual hardware blocks may be clock-gated automatically when idle to save dynamic power; each core clock may be gated when the core is not actively executing instructions due to execution of WFI/WFE instructions; each core may be independently power-gated; each core cluster may be independently clock-gated when all cores are clock-gated or power-gated; and/or each core cluster may be independently power-gated when all cores are power-gated. The CPU(s) 1006 may further implement an enhanced algorithm for managing power states, where allowed power states and expected wakeup times are specified, and the hardware/microcode determines the best power state to enter for the core, cluster, and CCPLEX. The processing cores may support simplified power state entry sequences in software with the work offloaded to microcode.

The GPU(s) 1008 may include an integrated GPU (alternatively referred to herein as an “iGPU”). The GPU(s) 1008 may be programmable and may be efficient for parallel workloads. The GPU(s) 1008, in some examples, may use an enhanced tensor instruction set. The GPU(s) 1008 may include one or more streaming microprocessors, where each streaming microprocessor may include an L1 cache (e.g., an L1 cache with at least 96 KB storage capacity), and two or more of the streaming microprocessors may share an L2 cache (e.g., an L2 cache with a 512 KB storage capacity). In some embodiments, the GPU(s) 1008 may include at least eight streaming microprocessors. The GPU(s) 1008 may use compute application programming interface(s) (API(s)). In addition, the GPU(s) 1008 may use one or more parallel computing platforms and/or programming models (e.g., NVIDIA's CUDA).

The GPU(s) 1008 may be power-optimized for best performance in automotive and embedded use cases. For example, the GPU(s) 1008 may be fabricated on a Fin field-effect transistor (FinFET). However, this is not intended to be limiting and the GPU(s) 1008 may be fabricated using other semiconductor manufacturing processes. Each streaming microprocessor may incorporate a number of mixed-precision processing cores partitioned into multiple blocks. For example, and without limitation, 64 PF32 cores and 32 PF64 cores may be partitioned into four processing blocks. In such an example, each processing block may be allocated 16 FP32 cores, 8 FP64 cores, 16 INT32 cores, two mixed-precision NVIDIA TENSOR COREs for deep learning matrix arithmetic, an L0 instruction cache, a warp scheduler, a dispatch unit, and/or a 64 KB register file. In addition, the streaming microprocessors may include independent parallel integer and floating-point data paths to provide for efficient execution of workloads with a mix of computation and addressing calculations. The streaming microprocessors may include independent thread scheduling capability to enable finer-grain synchronization and cooperation between parallel threads. The streaming microprocessors may include a combined L1 data cache and shared memory unit in order to improve performance while simplifying programming.

The GPU(s) 1008 may include a high bandwidth memory (HBM) and/or a 16 GB HBM2 memory subsystem to provide, in some examples, about 900 GB/second peak memory bandwidth. In some examples, in addition to, or alternatively from, the HBM memory, a synchronous graphics random-access memory (SGRAM) may be used, such as a graphics double data rate type five synchronous random-access memory (GDDR5).

The GPU(s) 1008 may include unified memory technology including access counters to allow for more accurate migration of memory pages to the processor that accesses them most frequently, thereby improving efficiency for memory ranges shared between processors. In some examples, address translation services (ATS) support may be used to allow the GPU(s) 1008 to access the CPU(s) 1006 page tables directly. In such examples, when the GPU(s) 1008 memory management unit (MMU) experiences a miss, an address translation request may be transmitted to the CPU(s) 1006. In response, the CPU(s) 1006 may look in its page tables for the virtual-to-physical mapping for the address and transmits the translation back to the GPU(s) 1008. As such, unified memory technology may allow a single unified virtual address space for memory of both the CPU(s) 1006 and the GPU(s) 1008, thereby simplifying the GPU(s) 1008 programming and porting of applications to the GPU(s) 1008.

In addition, the GPU(s) 1008 may include an access counter that may keep track of the frequency of access of the GPU(s) 1008 to memory of other processors. The access counter may help ensure that memory pages are moved to the physical memory of the processor that is accessing the pages most frequently.

The SoC(s) 1004 may include any number of cache(s) 1012, including those described herein. For example, the cache(s) 1012 may include an L3 cache that is available to both the CPU(s) 1006 and the GPU(s) 1008 (e.g., that is connected both the CPU(s) 1006 and the GPU(s) 1008). The cache(s) 1012 may include a write-back cache that may keep track of states of lines, such as by using a cache coherence protocol (e.g., MEI, MESI, MSI, etc.). The L3 cache may include 4 MB or more, depending on the embodiment, although smaller cache sizes may be used.

The SoC(s) 1004 may include an arithmetic logic unit(s) (ALU(s)) which may be leveraged in performing processing with respect to any of the variety of tasks or operations of the vehicle 1000—such as processing DNNs. In addition, the SoC(s) 1004 may include a floating point unit(s) (FPU(s))—or other math coprocessor or numeric coprocessor types - for performing mathematical operations within the system. For example, the SoC(s) 104 may include one or more FPUs integrated as execution units within a CPU(s) 1006 and/or GPU(s) 1008.

The SoC(s) 1004 may include one or more accelerators 1014 (e.g., hardware accelerators, software accelerators, or a combination thereof). For example, the SoC(s) 1004 may include a hardware acceleration cluster that may include optimized hardware accelerators and/or large on-chip memory. The large on-chip memory (e.g., 4 MB of SRAM), may enable the hardware acceleration cluster to accelerate neural networks and other calculations. The hardware acceleration cluster may be used to complement the GPU(s) 1008 and to off-load some of the tasks of the GPU(s) 1008 (e.g., to free up more cycles of the GPU(s) 1008 for performing other tasks). As an example, the accelerator(s) 1014 may be used for targeted workloads (e.g., perception, convolutional neural networks (CNNs), etc.) that are stable enough to be amenable to acceleration. The term “CNN,” as used herein, may include all types of CNNs, including region-based or regional convolutional neural networks (RCNNs) and Fast RCNNs (e.g., as used for object detection).

The accelerator(s) 1014 (e.g., the hardware acceleration cluster) may include a deep learning accelerator(s) (DLA). The DLA(s) may include one or more Tensor processing units (TPUs) that may be configured to provide an additional ten trillion operations per second for deep learning applications and inferencing. The TPUs may be accelerators configured to, and optimized for, performing image processing functions (e.g., for CNNs, RCNNs, etc.). The DLA(s) may further be optimized for a specific set of neural network types and floating point operations, as well as inferencing. The design of the DLA(s) may provide more performance per millimeter than a general-purpose GPU, and vastly exceeds the performance of a CPU. The TPU(s) may perform several functions, including a single-instance convolution function, supporting, for example, INT8, INT16, and FP16 data types for both features and weights, as well as post-processor functions.

The DLA(s) may quickly and efficiently execute neural networks, especially CNNs, on processed or unprocessed data for any of a variety of functions, including, for example and without limitation: a CNN for object identification and detection using data from camera sensors; a CNN for distance estimation using data from camera sensors; a CNN for emergency vehicle detection and identification and detection using data from microphones; a CNN for facial recognition and vehicle owner identification using data from camera sensors; and/or a CNN for security and/or safety related events.

The DLA(s) may perform any function of the GPU(s) 1008, and by using an inference accelerator, for example, a designer may target either the DLA(s) or the GPU(s) 1008 for any function. For example, the designer may focus processing of CNNs and floating point operations on the DLA(s) and leave other functions to the GPU(s) 1008 and/or other accelerator(s) 1014.

The accelerator(s) 1014 (e.g., the hardware acceleration cluster) may include a programmable vision accelerator(s) (PVA), which may alternatively be referred to herein as a computer vision accelerator. The PVA(s) may be designed and configured to accelerate computer vision algorithms for the advanced driver assistance systems (ADAS), autonomous driving, and/or augmented reality (AR) and/or virtual reality (VR) applications. The PVA(s) may provide a balance between performance and flexibility. For example, each PVA(s) may include, for example and without limitation, any number of reduced instruction set computer (RISC) cores, direct memory access (DMA), and/or any number of vector processors.

The RISC cores may interact with image sensors (e.g., the image sensors of any of the cameras described herein), image signal processor(s), and/or the like. Each of the RISC cores may include any amount of memory. The RISC cores may use any of a number of protocols, depending on the embodiment. In some examples, the RISC cores may execute a real-time operating system (RTOS). The RISC cores may be implemented using one or more integrated circuit devices, application specific integrated circuits (ASICs), and/or memory devices. For example, the RISC cores may include an instruction cache and/or a tightly coupled RAM.

The DMA may enable components of the PVA(s) to access the system memory independently of the CPU(s) 1006. The DMA may support any number of features used to provide optimization to the PVA including, but not limited to, supporting multi-dimensional addressing and/or circular addressing. In some examples, the DMA may support up to six or more dimensions of addressing, which may include block width, block height, block depth, horizontal block stepping, vertical block stepping, and/or depth stepping.

The vector processors may be programmable processors that may be designed to efficiently and flexibly execute programming for computer vision algorithms and provide signal processing capabilities. In some examples, the PVA may include a PVA core and two vector processing subsystem partitions. The PVA core may include a processor subsystem, DMA engine(s) (e.g., two DMA engines), and/or other peripherals. The vector processing subsystem may operate as the primary processing engine of the PVA, and may include a vector processing unit (VPU), an instruction cache, and/or vector memory (e.g., VMEM). A VPU core may include a digital signal processor such as, for example, a single instruction, multiple data (SIMD), very long instruction word (VLIW) digital signal processor. The combination of the SIMD and VLIW may enhance throughput and speed.

Each of the vector processors may include an instruction cache and may be coupled to dedicated memory. As a result, in some examples, each of the vector processors may be configured to execute independently of the other vector processors. In other examples, the vector processors that are included in a particular PVA may be configured to employ data parallelism. For example, in some embodiments, the plurality of vector processors included in a single PVA may execute the same computer vision algorithm, but on different regions of an image. In other examples, the vector processors included in a particular PVA may simultaneously execute different computer vision algorithms, on the same image, or even execute different algorithms on sequential images or portions of an image. Among other things, any number of PVAs may be included in the hardware acceleration cluster and any number of vector processors may be included in each of the PVAs. In addition, the PVA(s) may include additional error correcting code (ECC) memory, to enhance overall system safety.

The accelerator(s) 1014 (e.g., the hardware acceleration cluster) may include a computer vision network on-chip and SRAM, for providing a high-bandwidth, low latency SRAM for the accelerator(s) 1014. In some examples, the on-chip memory may include at least 4 MB SRAM, consisting of, for example and without limitation, eight field-configurable memory blocks, that may be accessible by both the PVA and the DLA. Each pair of memory blocks may include an advanced peripheral bus (APB) interface, configuration circuitry, a controller, and a multiplexer. Any type of memory may be used. The PVA and DLA may access the memory via a backbone that provides the PVA and DLA with high-speed access to memory. The backbone may include a computer vision network on-chip that interconnects the PVA and the DLA to the memory (e.g., using the APB).

The computer vision network on-chip may include an interface that determines, before transmission of any control signal/address/data, that both the PVA and the DLA provide ready and valid signals. Such an interface may provide for separate phases and separate channels for transmitting control signals/addresses/data, as well as burst-type communications for continuous data transfer. This type of interface may comply with ISO 26262 or IEC 61508 standards, although other standards and protocols may be used.

In some examples, the SoC(s) 1004 may include a real-time ray-tracing hardware accelerator, such as described in U.S. patent application Ser. No. 16/101,232, filed on Aug. 10, 2018. The real-time ray-tracing hardware accelerator may be used to quickly and efficiently determine the positions and extents of objects (e.g., within a world model), to generate real-time visualization simulations, for RADAR signal interpretation, for sound propagation synthesis and/or analysis, for simulation of SONAR systems, for general wave propagation simulation, for comparison to LIDAR data for purposes of localization and/or other functions, and/or for other uses. In some embodiments, one or more tree traversal units (TTUs) may be used for executing one or more ray-tracing related operations.

The accelerator(s) 1014 (e.g., the hardware accelerator cluster) have a wide array of uses for autonomous driving. The PVA may be a programmable vision accelerator that may be used for key processing stages in ADAS and autonomous vehicles. The PVA's capabilities are a good match for algorithmic domains needing predictable processing, at low power and low latency. In other words, the PVA performs well on semi-dense or dense regular computation, even on small data sets, which need predictable run-times with low latency and low power. Thus, in the context of platforms for autonomous vehicles, the PVAs are designed to run classic computer vision algorithms, as they are efficient at object detection and operating on integer math.

For example, according to one embodiment of the technology, the PVA is used to perform computer stereo vision. A semi-global matching-based algorithm may be used in some examples, although this is not intended to be limiting. Many applications for Level 3-5 autonomous driving require motion estimation/stereo matching on-the-fly (e.g., structure from motion, pedestrian recognition, lane detection, etc.). The PVA may perform computer stereo vision function on inputs from two monocular cameras.

In some examples, the PVA may be used to perform dense optical flow. According to process raw RADAR data (e.g., using a 4D Fast Fourier Transform) to provide Processed RADAR. In other examples, the PVA is used for time of flight depth processing, by processing raw time of flight data to provide processed time of flight data, for example.

The DLA may be used to run any type of network to enhance control and driving safety, including for example, a neural network that outputs a measure of confidence for each object detection. Such a confidence value may be interpreted as a probability, or as providing a relative “weight” of each detection compared to other detections. This confidence value enables the system to make further decisions regarding which detections should be considered as true positive detections rather than false positive detections. For example, the system may set a threshold value for the confidence and consider only the detections exceeding the threshold value as true positive detections. In an automatic emergency braking (AEB) system, false positive detections would cause the vehicle to automatically perform emergency braking, which is obviously undesirable. Therefore, only the most confident detections should be considered as triggers for AEB. The DLA may run a neural network for regressing the confidence value. The neural network may take as its input at least some subset of parameters, such as bounding box dimensions, ground plane estimate obtained (e.g. from another subsystem), inertial measurement unit (IMU) sensor 1066 output that correlates with the vehicle 1000 orientation, distance, 3D location estimates of the object obtained from the neural network and/or other sensors (e.g., LIDAR sensor(s) 1064 or RADAR sensor(s) 1060), among others.

The SoC(s) 1004 may include data store(s) 1016 (e.g., memory). The data store(s) 1016 may be on-chip memory of the SoC(s) 1004, which may store neural networks to be executed on the GPU and/or the DLA. In some examples, the data store(s) 1016 may be large enough in capacity to store multiple instances of neural networks for redundancy and safety. The data store(s) 1012 may comprise L2 or L3 cache(s) 1012. Reference to the data store(s) 1016 may include reference to the memory associated with the PVA, DLA, and/or other accelerator(s) 1014, as described herein.

The SoC(s) 1004 may include one or more processor(s) 1010 (e.g., embedded processors). The processor(s) 1010 may include a boot and power management processor that may be a dedicated processor and subsystem to handle boot power and management functions and related security enforcement. The boot and power management processor may be a part of the SoC(s) 1004 boot sequence and may provide runtime power management services. The boot power and management processor may provide clock and voltage programming, assistance in system low power state transitions, management of SoC(s) 1004 thermals and temperature sensors, and/or management of the SoC(s) 1004 power states. Each temperature sensor may be implemented as a ring-oscillator whose output frequency is proportional to temperature, and the SoC(s) 1004 may use the ring-oscillators to detect temperatures of the CPU(s) 1006, GPU(s) 1008, and/or accelerator(s) 1014. If temperatures are determined to exceed a threshold, the boot and power management processor may enter a temperature fault routine and put the SoC(s) 1004 into a lower power state and/or put the vehicle 1000 into a chauffeur to safe stop mode (e.g., bring the vehicle 1000 to a safe stop).

The processor(s) 1010 may further include a set of embedded processors that may serve as an audio processing engine. The audio processing engine may be an audio subsystem that enables full hardware support for multi-channel audio over multiple interfaces, and a broad and flexible range of audio I/O interfaces. In some examples, the audio processing engine is a dedicated processor core with a digital signal processor with dedicated RAM.

The processor(s) 1010 may further include an always on processor engine that may provide necessary hardware features to support low power sensor management and wake use cases. The always on processor engine may include a processor core, a tightly coupled RAM, supporting peripherals (e.g., timers and interrupt controllers), various I/O controller peripherals, and routing logic.

The processor(s) 1010 may further include a safety cluster engine that includes a dedicated processor subsystem to handle safety management for automotive applications. The safety cluster engine may include two or more processor cores, a tightly coupled RAM, support peripherals (e.g., timers, an interrupt controller, etc.), and/or routing logic. In a safety mode, the two or more cores may operate in a lockstep mode and function as a single core with comparison logic to detect any differences between their operations.

The processor(s) 1010 may further include a real-time camera engine that may include a dedicated processor subsystem for handling real-time camera management.

The processor(s) 1010 may further include a high-dynamic range signal processor that may include an image signal processor that is a hardware engine that is part of the camera processing pipeline.

The processor(s) 1010 may include a video image compositor that may be a processing block (e.g., implemented on a microprocessor) that implements video post-processing functions needed by a video playback application to produce the final image for the player window. The video image compositor may perform lens distortion correction on wide-view camera(s) 1070, surround camera(s) 1074, and/or on in-cabin monitoring camera sensors. In-cabin monitoring camera sensor is preferably monitored by a neural network running on another instance of the Advanced SoC, configured to identify in cabin events and respond accordingly. An in-cabin system may perform lip reading to activate cellular service and place a phone call, dictate emails, change the vehicle's destination, activate or change the vehicle's infotainment system and settings, or provide voice-activated web surfing. Certain functions are available to the driver only when the vehicle is operating in an autonomous mode, and are disabled otherwise.

The video image compositor may include enhanced temporal noise reduction for both spatial and temporal noise reduction. For example, where motion occurs in a video, the noise reduction weights spatial information appropriately, decreasing the weight of information provided by adjacent frames. Where an image or portion of an image does not include motion, the temporal noise reduction performed by the video image compositor may use information from the previous image to reduce noise in the current image.

The video image compositor may also be configured to perform stereo rectification on input stereo lens frames. The video image compositor may further be used for user interface composition when the operating system desktop is in use, and the GPU(s) 1008 is not required to continuously render new surfaces. Even when the GPU(s) 1008 is powered on and active doing 3D rendering, the video image compositor may be used to offload the GPU(s) 1008 to improve performance and responsiveness.

The SoC(s) 1004 may further include a mobile industry processor interface (MIPI) camera serial interface for receiving video and input from cameras, a high-speed interface, and/or a video input block that may be used for camera and related pixel input functions. The SoC(s) 1004 may further include an input/output controller(s) that may be controlled by software and may be used for receiving I/O signals that are uncommitted to a specific role.

The SoC(s) 1004 may further include a broad range of peripheral interfaces to enable communication with peripherals, audio codecs, power management, and/or other devices. The SoC(s) 1004 may be used to process data from cameras (e.g., connected over Gigabit Multimedia Serial Link and Ethernet), sensors (e.g., LIDAR sensor(s) 1064, RADAR sensor(s) 1060, etc. that may be connected over Ethernet), data from bus 1002 (e.g., speed of vehicle 1000, steering wheel position, etc.), data from GNSS sensor(s) 1058 (e.g., connected over Ethernet or CAN bus). The SoC(s) 1004 may further include dedicated high-performance mass storage controllers that may include their own DMA engines, and that may be used to free the CPU(s) 1006 from routine data management tasks.

The SoC(s) 1004 may be an end-to-end platform with a flexible architecture that spans automation levels 3-5, thereby providing a comprehensive functional safety architecture that leverages and makes efficient use of computer vision and ADAS techniques for diversity and redundancy, provides a platform for a flexible, reliable driving software stack, along with deep learning tools. The SoC(s) 1004 may be faster, more reliable, and even more energy-efficient and space-efficient than conventional systems. For example, the accelerator(s) 1014, when combined with the CPU(s) 1006, the GPU(s) 1008, and the data store(s) 1016, may provide for a fast, efficient platform for level 3-5 autonomous vehicles.

The technology thus provides capabilities and functionality that cannot be achieved by conventional systems. For example, computer vision algorithms may be executed on CPUs, which may be configured using high-level programming language, such as the C programming language, to execute a wide variety of processing algorithms across a wide variety of visual data. However, CPUs are oftentimes unable to meet the performance requirements of many computer vision applications, such as those related to execution time and power consumption, for example. In particular, many CPUs are unable to execute complex object detection algorithms in real-time, which is a requirement of in-vehicle ADAS applications, and a requirement for practical Level 3-5 autonomous vehicles.

In contrast to conventional systems, by providing a CPU complex, GPU complex, and a hardware acceleration cluster, the technology described herein allows for multiple neural networks to be performed simultaneously and/or sequentially, and for the results to be combined together to enable Level 3-5 autonomous driving functionality. For example, a CNN executing on the DLA or dGPU (e.g., the GPU(s) 1020) may include a text and word recognition, allowing the supercomputer to read and understand traffic signs, including signs for which the neural network has not been specifically trained. The DLA may further include a neural network that is able to identify, interpret, and provides semantic understanding of the sign, and to pass that semantic understanding to the path planning modules running on the CPU Complex.

As another example, multiple neural networks may be run simultaneously, as is required for Level 3, 4, or 5 driving. For example, a warning sign consisting of “Caution: flashing lights indicate icy conditions,” along with an electric light, may be independently or collectively interpreted by several neural networks. The sign itself may be identified as a traffic sign by a first deployed neural network (e.g., a neural network that has been trained), the text “Flashing lights indicate icy conditions” may be interpreted by a second deployed neural network, which informs the vehicle's path planning software (preferably executing on the CPU Complex) that when flashing lights are detected, icy conditions exist. The flashing light may be identified by operating a third deployed neural network over multiple frames, informing the vehicle's path-planning software of the presence (or absence) of flashing lights. All three neural networks may run simultaneously, such as within the DLA and/or on the GPU(s) 1008.

In some examples, a CNN for facial recognition and vehicle owner identification may use data from camera sensors to identify the presence of an authorized driver and/or owner of the vehicle 1000. The always on sensor processing engine may be used to unlock the vehicle when the owner approaches the driver door and turn on the lights, and, in security mode, to disable the vehicle when the owner leaves the vehicle. In this way, the SoC(s) 1004 provide for security against theft and/or carjacking.

In another example, a CNN for emergency vehicle detection and identification may use data from microphones 1096 to detect and identify emergency vehicle sirens. In contrast to conventional systems, that use general classifiers to detect sirens and manually extract features, the SoC(s) 1004 use the CNN for classifying environmental and urban sounds, as well as classifying visual data. In a preferred embodiment, the CNN running on the DLA is trained to identify the relative closing speed of the emergency vehicle (e.g., by using the Doppler Effect). The CNN may also be trained to identify emergency vehicles specific to the local area in which the vehicle is operating, as identified by GNSS sensor(s) 1058. Thus, for example, when operating in Europe the CNN will seek to detect European sirens, and when in the United States the CNN will seek to identify only North American sirens. Once an emergency vehicle is detected, a control program may be used to execute an emergency vehicle safety routine, slowing the vehicle, pulling over to the side of the road, parking the vehicle, and/or idling the vehicle, with the assistance of ultrasonic sensors 1062, until the emergency vehicle(s) passes.

The vehicle may include a CPU(s) 1018 (e.g., discrete CPU(s), or dCPU(s)), that may be coupled to the SoC(s) 1004 via a high-speed interconnect (e.g., PCIe). The CPU(s) 1018 may include an X86 processor, for example. The CPU(s) 1018 may be used to perform any of a variety of functions, including arbitrating potentially inconsistent results between ADAS sensors and the SoC(s) 1004, and/or monitoring the status and health of the controller(s) 1036 and/or infotainment SoC 1030, for example.

The vehicle 1000 may include a GPU(s) 1020 (e.g., discrete GPU(s), or dGPU(s)), that may be coupled to the SoC(s) 1004 via a high-speed interconnect (e.g., NVIDIA's NVLINK). The GPU(s) 1020 may provide additional artificial intelligence functionality, such as by executing redundant and/or different neural networks, and may be used to train and/or update neural networks based on input (e.g., sensor data) from sensors of the vehicle 1000.

The vehicle 1000 may further include the network interface 1024 which may include one or more wireless antennas 1026 (e.g., one or more wireless antennas for different communication protocols, such as a cellular antenna, a Bluetooth antenna, etc.). The network interface 1024 may be used to enable wireless connectivity over the Internet with the cloud (e.g., with the server(s) 1078 and/or other network devices), with other vehicles, and/or with computing devices (e.g., client devices of passengers). To communicate with other vehicles, a direct link may be established between the two vehicles and/or an indirect link may be established (e.g., across networks and over the Internet). Direct links may be provided using a vehicle-to-vehicle communication link. The vehicle-to-vehicle communication link may provide the vehicle 1000 information about vehicles in proximity to the vehicle 1000 (e.g., vehicles in front of, on the side of, and/or behind the vehicle 1000). This functionality may be part of a cooperative adaptive cruise control functionality of the vehicle 1000.

The network interface 1024 may include a SoC that provides modulation and demodulation functionality and enables the controller(s) 1036 to communicate over wireless networks. The network interface 1024 may include a radio frequency front-end for up-conversion from baseband to radio frequency, and down conversion from radio frequency to baseband. The frequency conversions may be performed through well-known processes, and/or may be performed using super-heterodyne processes. In some examples, the radio frequency front end functionality may be provided by a separate chip. The network interface may include wireless functionality for communicating over LTE, WCDMA, UMTS, GSM, CDMA2000, Bluetooth, Bluetooth LE, Wi-Fi, Z-Wave, ZigBee, LoRaWAN, and/or other wireless protocols.

The vehicle 1000 may further include data store(s) 1028 which may include off-chip (e.g., off the SoC(s) 1004) storage. The data store(s) 1028 may include one or more storage elements including RAM, SRAM, DRAM, VRAM, Flash, hard disks, and/or other components and/or devices that may store at least one bit of data.

The vehicle 1000 may further include GNSS sensor(s) 1058. The GNSS sensor(s) 1058 (e.g., GPS, assisted GPS sensors, differential GPS (DGPS) sensors, etc.), to assist in mapping, perception, occupancy grid generation, and/or path planning functions. Any number of GNSS sensor(s) 1058 may be used, including, for example and without limitation, a GPS using a USB connector with an Ethernet to Serial (RS-232) bridge.

The vehicle 1000 may further include RADAR sensor(s) 1060. The RADAR sensor(s) 1060 may be used by the vehicle 1000 for long-range vehicle detection, even in darkness and/or severe weather conditions. RADAR functional safety levels may be ASIL B. The RADAR sensor(s) 1060 may use the CAN and/or the bus 1002 (e.g., to transmit data generated by the RADAR sensor(s) 1060) for control and to access object tracking data, with access to Ethernet to access raw data in some examples. A wide variety of RADAR sensor types may be used. For example, and without limitation, the RADAR sensor(s) 1060 may be suitable for front, rear, and side RADAR use. In some example, Pulse Doppler RADAR sensor(s) are used.

The RADAR sensor(s) 1060 may include different configurations, such as long range with narrow field of view, short range with wide field of view, short range side coverage, etc. In some examples, long-range RADAR may be used for adaptive cruise control functionality. The long-range RADAR systems may provide a broad field of view realized by two or more independent scans, such as within a 250 m range. The RADAR sensor(s) 1060 may help in distinguishing between static and moving objects, and may be used by ADAS systems for emergency brake assist and forward collision warning. Long-range RADAR sensors may include monostatic multimodal RADAR with multiple (e.g., six or more) fixed RADAR antennae and a high-speed CAN and FlexRay interface. In an example with six antennae, the central four antennae may create a focused beam pattern, designed to record the vehicle's 1000 surroundings at higher speeds with minimal interference from traffic in adjacent lanes. The other two antennae may expand the field of view, making it possible to quickly detect vehicles entering or leaving the vehicle's 1000 lane.

Mid-range RADAR systems may include, as an example, a range of up to 1060 m (front) or 80 m (rear), and a field of view of up to 42 degrees (front) or 1050 degrees (rear). Short-range RADAR systems may include, without limitation, RADAR sensors designed to be installed at both ends of the rear bumper. When installed at both ends of the rear bumper, such a RADAR sensor systems may create two beams that constantly monitor the blind spot in the rear and next to the vehicle.

Short-range RADAR systems may be used in an ADAS system for blind spot detection and/or lane change assist.

The vehicle 1000 may further include ultrasonic sensor(s) 1062. The ultrasonic sensor(s) 1062, which may be positioned at the front, back, and/or the sides of the vehicle 1000, may be used for park assist and/or to create and update an occupancy grid. A wide variety of ultrasonic sensor(s) 1062 may be used, and different ultrasonic sensor(s) 1062 may be used for different ranges of detection (e.g., 2.5 m, 4 m). The ultrasonic sensor(s) 1062 may operate at functional safety levels of ASIL B.

The vehicle 1000 may include LIDAR sensor(s) 1064. The LIDAR sensor(s) 1064 may be used for object and pedestrian detection, emergency braking, collision avoidance, and/or other functions. The LIDAR sensor(s) 1064 may be functional safety level ASIL B. In some examples, the vehicle 1000 may include multiple LIDAR sensors 1064 (e.g., two, four, six, etc.) that may use Ethernet (e.g., to provide data to a Gigabit Ethernet switch).

In some examples, the LIDAR sensor(s) 1064 may be capable of providing a list of objects and their distances for a 360-degree field of view. Commercially available LIDAR sensor(s) 1064 may have an advertised range of approximately 1000 m, with an accuracy of 2 cm-3 cm, and with support for a 1000 Mbps Ethernet connection, for example. In some examples, one or more non-protruding LIDAR sensors 1064 may be used. In such examples, the LIDAR sensor(s) 1064 may be implemented as a small device that may be embedded into the front, rear, sides, and/or corners of the vehicle 1000. The LIDAR sensor(s) 1064, in such examples, may provide up to a 120-degree horizontal and 35-degree vertical field-of-view, with a 200 m range even for low-reflectivity objects. Front-mounted LIDAR sensor(s) 1064 may be configured for a horizontal field of view between 45 degrees and 135 degrees.

In some examples, LIDAR technologies, such as 3D flash LIDAR, may also be used. 3D Flash LIDAR uses a flash of a laser as a transmission source, to illuminate vehicle surroundings up to approximately 200 m. A flash LIDAR unit includes a receptor, which records the laser pulse transit time and the reflected light on each pixel, which in turn corresponds to the range from the vehicle to the objects. Flash LIDAR may allow for highly accurate and distortion-free images of the surroundings to be generated with every laser flash. In some examples, four flash LIDAR sensors may be deployed, one at each side of the vehicle 1000. Available 3D flash LIDAR systems include a solid-state 3D staring array LIDAR camera with no moving parts other than a fan (e.g., a non-scanning LIDAR device). The flash LIDAR device may use a 5 nanosecond class I (eye-safe) laser pulse per frame and may capture the reflected laser light in the form of 3D range point clouds and co-registered intensity data. By using flash LIDAR, and because flash LIDAR is a solid-state device with no moving parts, the LIDAR sensor(s) 1064 may be less susceptible to motion blur, vibration, and/or shock.

The vehicle may further include IMU sensor(s) 1066. The IMU sensor(s) 1066 may be located at a center of the rear axle of the vehicle 1000, in some examples. The IMU sensor(s) 1066 may include, for example and without limitation, an accelerometer(s), a magnetometer(s), a gyroscope(s), a magnetic compass(es), and/or other sensor types. In some examples, such as in six-axis applications, the IMU sensor(s) 1066 may include accelerometers and gyroscopes, while in nine-axis applications, the IMU sensor(s) 1066 may include accelerometers, gyroscopes, and magnetometers.

In some embodiments, the IMU sensor(s) 1066 may be implemented as a miniature, high performance GPS-Aided Inertial Navigation System (GPS/INS) that combines micro-electro-mechanical systems (MEMS) inertial sensors, a high-sensitivity GPS receiver, and advanced Kalman filtering algorithms to provide estimates of position, velocity, and attitude. As such, in some examples, the IMU sensor(s) 1066 may enable the vehicle 1000 to estimate heading without requiring input from a magnetic sensor by directly observing and correlating the changes in velocity from GPS to the IMU sensor(s) 1066. In some examples, the IMU sensor(s) 1066 and the GNSS sensor(s) 1058 may be combined in a single integrated unit.

The vehicle may include microphone(s) 1096 placed in and/or around the vehicle 1000. The microphone(s) 1096 may be used for emergency vehicle detection and identification, among other things.

The vehicle may further include any number of camera types, including stereo camera(s) 1068, wide-view camera(s) 1070, infrared camera(s) 1072, surround camera(s) 1074, long-range and/or mid-range camera(s) 1098, and/or other camera types. The cameras may be used to capture image data around an entire periphery of the vehicle 1000. The types of cameras used depends on the embodiments and requirements for the vehicle 1000, and any combination of camera types may be used to provide the necessary coverage around the vehicle 1000. In addition, the number of cameras may differ depending on the embodiment. For example, the vehicle may include six cameras, seven cameras, ten cameras, twelve cameras, and/or another number of cameras. The cameras may support, as an example and without limitation, Gigabit Multimedia Serial Link (GMSL) and/or Gigabit Ethernet. Each of the camera(s) is described with more detail herein with respect to FIG. 10A and FIG. 10B.

The vehicle 1000 may further include vibration sensor(s) 1042. The vibration sensor(s) 1042 may measure vibrations of components of the vehicle, such as the axle(s). For example, changes in vibrations may indicate a change in road surfaces. In another example, when two or more vibration sensors 1042 are used, the differences between the vibrations may be used to determine friction or slippage of the road surface (e.g., when the difference in vibration is between a power-driven axle and a freely rotating axle).

The vehicle 1000 may include an ADAS system 1038. The ADAS system 1038 may include a SoC, in some examples. The ADAS system 1038 may include autonomous/adaptive/automatic cruise control (ACC), cooperative adaptive cruise control (CACC), forward crash warning (FCW), automatic emergency braking (AEB), lane departure warnings (LDW), lane keep assist (LKA), blind spot warning (BSW), rear cross-traffic warning (RCTW), collision warning systems (CWS), lane centering (LC), and/or other features and functionality.

The ACC systems may use RADAR sensor(s) 1060, LIDAR sensor(s) 1064, and/or a camera(s). The ACC systems may include longitudinal ACC and/or lateral ACC. Longitudinal ACC monitors and controls the distance to the vehicle immediately ahead of the vehicle 1000 and automatically adjust the vehicle speed to maintain a safe distance from vehicles ahead. Lateral ACC performs distance keeping, and advises the vehicle 1000 to change lanes when necessary. Lateral ACC is related to other ADAS applications such as LCA and CWS.

CACC uses information from other vehicles that may be received via the network interface 1024 and/or the wireless antenna(s) 1026 from other vehicles via a wireless link, or indirectly, over a network connection (e.g., over the Internet). Direct links may be provided by a vehicle-to-vehicle (V2V) communication link, while indirect links may be infrastructure-to-vehicle (I2V) communication link. In general, the V2V communication concept provides information about the immediately preceding vehicles (e.g., vehicles immediately ahead of and in the same lane as the vehicle 1000), while the I2V communication concept provides information about traffic further ahead. CACC systems may include either or both I2V and V2V information sources. Given the information of the vehicles ahead of the vehicle 1000, CACC may be more reliable and it has potential to improve traffic flow smoothness and reduce congestion on the road.

FCW systems are designed to alert the driver to a hazard, so that the driver may take corrective action. FCW systems use a front-facing camera and/or RADAR sensor(s) 1060, coupled to a dedicated processor, DSP, FPGA, and/or ASIC, that is electrically coupled to driver feedback, such as a display, speaker, and/or vibrating component. FCW systems may provide a warning, such as in the form of a sound, visual warning, vibration and/or a quick brake pulse.

AEB systems detect an impending forward collision with another vehicle or other object, and may automatically apply the brakes if the driver does not take corrective action within a specified time or distance parameter. AEB systems may use front-facing camera(s) and/or RADAR sensor(s) 1060, coupled to a dedicated processor, DSP, FPGA, and/or ASIC. When the AEB system detects a hazard, it typically first alerts the driver to take corrective action to avoid the collision and, if the driver does not take corrective action, the AEB system may automatically apply the brakes in an effort to prevent, or at least mitigate, the impact of the predicted collision. AEB systems, may include techniques such as dynamic brake support and/or crash imminent braking.

LDW systems provide visual, audible, and/or tactile warnings, such as steering wheel or seat vibrations, to alert the driver when the vehicle 1000 crosses lane markings. A LDW system does not activate when the driver indicates an intentional lane departure, by activating a turn signal. LDW systems may use front-side facing cameras, coupled to a dedicated processor, DSP, FPGA, and/or ASIC, that is electrically coupled to driver feedback, such as a display, speaker, and/or vibrating component.

LKA systems are a variation of LDW systems. LKA systems provide steering input or braking to correct the vehicle 1000 if the vehicle 1000 starts to exit the lane.

BSW systems detects and warn the driver of vehicles in an automobile's blind spot. BSW systems may provide a visual, audible, and/or tactile alert to indicate that merging or changing lanes is unsafe. The system may provide an additional warning when the driver uses a turn signal. BSW systems may use rear-side facing camera(s) and/or RADAR sensor(s) 1060, coupled to a dedicated processor, DSP, FPGA, and/or ASIC, that is electrically coupled to driver feedback, such as a display, speaker, and/or vibrating component.

RCTW systems may provide visual, audible, and/or tactile notification when an object is detected outside the rear-camera range when the vehicle 1000 is backing up. Some RCTW systems include AEB to ensure that the vehicle brakes are applied to avoid a crash. RCTW systems may use one or more rear-facing RADAR sensor(s) 1060, coupled to a dedicated processor, DSP, FPGA, and/or ASIC, that is electrically coupled to driver feedback, such as a display, speaker, and/or vibrating component.

Conventional ADAS systems may be prone to false positive results which may be annoying and distracting to a driver, but typically are not catastrophic, because the ADAS systems alert the driver and allow the driver to decide whether a safety condition truly exists and act accordingly. However, in an autonomous vehicle 1000, the vehicle 1000 itself must, in the case of conflicting results, decide whether to heed the result from a primary computer or a secondary computer (e.g., a first controller 1036 or a second controller 1036). For example, in some embodiments, the ADAS system 1038 may be a backup and/or secondary computer for providing perception information to a backup computer rationality module. The backup computer rationality monitor may run a redundant diverse software on hardware components to detect faults in perception and dynamic driving tasks. Outputs from the ADAS system 1038 may be provided to a supervisory MCU. If outputs from the primary computer and the secondary computer conflict, the supervisory MCU must determine how to reconcile the conflict to ensure safe operation.

In some examples, the primary computer may be configured to provide the supervisory MCU with a confidence score, indicating the primary computer's confidence in the chosen result. If the confidence score exceeds a threshold, the supervisory MCU may follow the primary computer's direction, regardless of whether the secondary computer provides a conflicting or inconsistent result. Where the confidence score does not meet the threshold, and where the primary and secondary computer indicate different results (e.g., the conflict), the supervisory MCU may arbitrate between the computers to determine the appropriate outcome.

The supervisory MCU may be configured to run a neural network(s) that is trained and configured to determine, based on outputs from the primary computer and the secondary computer, conditions under which the secondary computer provides false alarms. Thus, the neural network(s) in the supervisory MCU may learn when the secondary computer's output may be trusted, and when it cannot. For example, when the secondary computer is a RADAR-based FCW system, a neural network(s) in the supervisory MCU may learn when the FCW system is identifying metallic objects that are not, in fact, hazards, such as a drainage grate or manhole cover that triggers an alarm. Similarly, when the secondary computer is a camera-based LDW system, a neural network in the supervisory MCU may learn to override the LDW when bicyclists or pedestrians are present and a lane departure is, in fact, the safest maneuver. In embodiments that include a neural network(s) running on the supervisory MCU, the supervisory MCU may include at least one of a DLA or GPU suitable for running the neural network(s) with associated memory. In preferred embodiments, the supervisory MCU may comprise and/or be included as a component of the SoC(s) 1004.

In other examples, ADAS system 1038 may include a secondary computer that performs ADAS functionality using traditional rules of computer vision. As such, the secondary computer may use classic computer vision rules (if-then), and the presence of a neural network(s) in the supervisory MCU may improve reliability, safety and performance. For example, the diverse implementation and intentional non-identity makes the overall system more fault-tolerant, especially to faults caused by software (or software-hardware interface) functionality. For example, if there is a software bug or error in the software running on the primary computer, and the non-identical software code running on the secondary computer provides the same overall result, the supervisory MCU may have greater confidence that the overall result is correct, and the bug in software or hardware on primary computer is not causing material error.

In some examples, the output of the ADAS system 1038 may be fed into the primary computer's perception block and/or the primary computer's dynamic driving task block. For example, if the ADAS system 1038 indicates a forward crash warning due to an object immediately ahead, the perception block may use this information when identifying objects. In other examples, the secondary computer may have its own neural network which is trained and thus reduces the risk of false positives, as described herein.

The vehicle 1000 may further include the infotainment SoC 1030 (e.g., an in-vehicle infotainment system (IVI)). Although illustrated and described as a SoC, the infotainment system may not be a SoC, and may include two or more discrete components. The infotainment SoC 1030 may include a combination of hardware and software that may be used to provide audio (e.g., music, a personal digital assistant, navigational instructions, news, radio, etc.), video (e.g., TV, movies, streaming, etc.), phone (e.g., hands-free calling), network connectivity (e.g., LTE, Wi-Fi, etc.), and/or information services (e.g., navigation systems, rear-parking assistance, a radio data system, vehicle related information such as fuel level, total distance covered, brake fuel level, oil level, door open/close, air filter information, etc.) to the vehicle 1000. For example, the infotainment SoC 1030 may radios, disk players, navigation systems, video players, USB and Bluetooth connectivity, carputers, in-car entertainment, Wi-Fi, steering wheel audio controls, hands free voice control, a heads-up display (HUD), an HMI display 1034, a telematics device, a control panel (e.g., for controlling and/or interacting with various components, features, and/or systems), and/or other components. The infotainment SoC 1030 may further be used to provide information (e.g., visual and/or audible) to a user(s) of the vehicle, such as information from the ADAS system 1038, autonomous driving information such as planned vehicle maneuvers, trajectories, surrounding environment information (e.g., intersection information, vehicle information, road information, etc.), and/or other information.

The infotainment SoC 1030 may include GPU functionality. The infotainment SoC 1030 may communicate over the bus 1002 (e.g., CAN bus, Ethernet, etc.) with other devices, systems, and/or components of the vehicle 1000. In some examples, the infotainment SoC 1030 may be coupled to a supervisory MCU such that the GPU of the infotainment system may perform some self-driving functions in the event that the primary controller(s) 1036 (e.g., the primary and/or backup computers of the vehicle 1000) fail. In such an example, the infotainment SoC 1030 may put the vehicle 1000 into a chauffeur to safe stop mode, as described herein.

The vehicle 1000 may further include an instrument cluster 1032 (e.g., a digital dash, an electronic instrument cluster, a digital instrument panel, etc.). The instrument cluster 1032 may include a controller and/or supercomputer (e.g., a discrete controller or supercomputer). The instrument cluster 1032 may include a set of instrumentation such as a speedometer, fuel level, oil pressure, tachometer, odometer, turn indicators, gearshift position indicator, seat belt warning light(s), parking-brake warning light(s), engine-malfunction light(s), airbag (SRS) system information, lighting controls, safety system controls, navigation information, etc. In some examples, information may be displayed and/or shared among the infotainment SoC 1030 and the instrument cluster 1032. In other words, the instrument cluster 1032 may be included as part of the infotainment SoC 1030, or vice versa.

FIG. 10D is a system diagram for communication between cloud-based server(s) and the example autonomous vehicle 1000 of FIG. 10A, in accordance with some embodiments of the present disclosure. The system 1076 may include server(s) 1078, network(s) 1090, and vehicles, including the vehicle 1000. The server(s) 1078 may include a plurality of GPUs 1084(A)-1084(H) (collectively referred to herein as GPUs 1084), PCIe switches 1082(A)-1082(H) (collectively referred to herein as PCIe switches 1082), and/or CPUs 1080(A)-1080(B) (collectively referred to herein as CPUs 1080). The GPUs 1084, the CPUs 1080, and the PCIe switches may be interconnected with high-speed interconnects such as, for example and without limitation, NVLink interfaces 1088 developed by NVIDIA and/or PCIe connections 1086. In some examples, the GPUs 1084 are connected via NVLink and/or NVSwitch SoC and the GPUs 1084 and the PCIe switches 1082 are connected via PCIe interconnects. Although eight GPUs 1084, two CPUs 1080, and two PCIe switches are illustrated, this is not intended to be limiting. Depending on the embodiment, each of the server(s) 1078 may include any number of GPUs 1084, CPUs 1080, and/or PCIe switches. For example, the server(s) 1078 may each include eight, sixteen, thirty-two, and/or more GPUs 1084.

The server(s) 1078 may receive, over the network(s) 1090 and from the vehicles, image data representative of images showing unexpected or changed road conditions, such as recently commenced road-work. The server(s) 1078 may transmit, over the network(s) 1090 and to the vehicles, neural networks 1092, updated neural networks 1092, and/or map information 1094, including information regarding traffic and road conditions. The updates to the map information 1094 may include updates for the HD map 1022, such as information regarding construction sites, potholes, detours, flooding, and/or other obstructions. In some examples, the neural networks 1092, the updated neural networks 1092, and/or the map information 1094 may have resulted from new training and/or experiences represented in data received from any number of vehicles in the environment, and/or based on training performed at a datacenter (e.g., using the server(s) 1078 and/or other servers).

The server(s) 1078 may be used to train machine learning models (e.g., neural networks) based on training data. The training data may be generated by the vehicles, and/or may be generated in a simulation (e.g., using a game engine). In some examples, the training data is tagged (e.g., where the neural network benefits from supervised learning) and/or undergoes other pre-processing, while in other examples the training data is not tagged and/or pre-processed (e.g., where the neural network does not require supervised learning). Training may be executed according to any one or more classes of machine learning techniques, including, without limitation, classes such as: supervised training, semi-supervised training, unsupervised training, self-learning, reinforcement learning, federated learning, transfer learning, feature learning (including principal component and cluster analyses), multi-linear subspace learning, manifold learning, representation learning (including spare dictionary learning), rule-based machine learning, anomaly detection, and any variants or combinations therefor. Once the machine learning models are trained, the machine learning models may be used by the vehicles (e.g., transmitted to the vehicles over the network(s) 1090, and/or the machine learning models may be used by the server(s) 1078 to remotely monitor the vehicles.

In some examples, the server(s) 1078 may receive data from the vehicles and apply the data to up-to-date real-time neural networks for real-time intelligent inferencing. The server(s) 1078 may include deep-learning supercomputers and/or dedicated AI computers powered by GPU(s) 1084, such as a DGX and DGX Station machines developed by NVIDIA. However, in some examples, the server(s) 1078 may include deep learning infrastructure that use only CPU-powered datacenters.

The deep-learning infrastructure of the server(s) 1078 may be capable of fast, real-time inferencing, and may use that capability to evaluate and verify the health of the processors, software, and/or associated hardware in the vehicle 1000. For example, the deep-learning infrastructure may receive periodic updates from the vehicle 1000, such as a sequence of images and/or objects that the vehicle 1000 has located in that sequence of images (e.g., via computer vision and/or other machine learning object classification techniques). The deep-learning infrastructure may run its own neural network to identify the objects and compare them with the objects identified by the vehicle 1000 and, if the results do not match and the infrastructure concludes that the AI in the vehicle 1000 is malfunctioning, the server(s) 1078 may transmit a signal to the vehicle 1000 instructing a fail-safe computer of the vehicle 1000 to assume control, notify the passengers, and complete a safe parking maneuver.

For inferencing, the server(s) 1078 may include the GPU(s) 1084 and one or more programmable inference accelerators (e.g., NVIDIA's TensorRT). The combination of GPU-powered servers and inference acceleration may make real-time responsiveness possible. In other examples, such as where performance is less critical, servers powered by CPUs, FPGAs, and other processors may be used for inferencing.

### Example Computing Device

FIG. 11 is a block diagram of an example computing device(s) 1100 suitable for use in implementing some embodiments of the present disclosure. Computing device 1100 may include an interconnect system 1102 that directly or indirectly couples the following devices: memory 1104, one or more central processing units (CPUs) 1106, one or more graphics processing units (GPUs) 1108, a communication interface 1110, input/output (I/O) ports 1112, input/output components 1114, a power supply 1116, one or more presentation components 1118 (e.g., display(s)), and one or more logic units 1120. In at least one embodiment, the computing device(s) 1100 may comprise one or more virtual machines (VMs), and/or any of the components thereof may comprise virtual components (e.g., virtual hardware components). For non-limiting examples, one or more of the GPUs 1108 may comprise one or more vGPUs, one or more of the CPUs 1106 may comprise one or more vCPUs, and/or one or more of the logic units 1120 may comprise one or more virtual logic units. As such, a computing device(s) 1100 may include discrete components (e.g., a full GPU dedicated to the computing device 1100), virtual components (e.g., a portion of a GPU dedicated to the computing device 1100), or a combination thereof.

Although the various blocks of FIG. 11 are shown as connected via the interconnect system 1102 with lines, this is not intended to be limiting and is for clarity only. For example, in some embodiments, a presentation component 1118, such as a display device, may be considered an I/O component 1114 (e.g., if the display is a touch screen). As another example, the CPUs 1106 and/or GPUs 1108 may include memory (e.g., the memory 1104 may be representative of a storage device in addition to the memory of the GPUs 1108, the CPUs 1106, and/or other components). In other words, the computing device of FIG. 11 is merely illustrative. Distinction is not made between such categories as “workstation,” “server,” “laptop,” “desktop,” “tablet,” “client device,” “mobile device,” “hand-held device,” “game console,” “electronic control unit (ECU),” “virtual reality system,” and/or other device or system types, as all are contemplated within the scope of the computing device of FIG. 11.

The interconnect system 1102 may represent one or more links or busses, such as an address bus, a data bus, a control bus, or a combination thereof. The interconnect system 1102 may include one or more bus or link types, such as an industry standard architecture (ISA) bus, an extended industry standard architecture (EISA) bus, a video electronics standards association (VESA) bus, a peripheral component interconnect (PCI) bus, a peripheral component interconnect express (PCIe) bus, and/or another type of bus or link. In some embodiments, there are direct connections between components. As an example, the CPU 1106 may be directly connected to the memory 1104. Further, the CPU 1106 may be directly connected to the GPU 1108. Where there is direct, or point-to-point connection between components, the interconnect system 1102 may include a PCIe link to carry out the connection. In these examples, a PCI bus need not be included in the computing device 1100.

The memory 1104 may include any of a variety of computer-readable media. The computer-readable media may be any available media that may be accessed by the computing device 1100. The computer-readable media may include both volatile and nonvolatile media, and removable and non-removable media. By way of example, and not limitation, the computer-readable media may comprise computer-storage media and communication media.

The computer-storage media may include both volatile and nonvolatile media and/or removable and non-removable media implemented in any method or technology for storage of information such as computer-readable instructions, data structures, program modules, and/or other data types. For example, the memory 1104 may store computer-readable instructions (e.g., that represent a program(s) and/or a program element(s), such as an operating system. Computer-storage media may include, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which may be used to store the desired information and which may be accessed by computing device 1100. As used herein, computer storage media does not comprise signals per se.

The computer storage media may embody computer-readable instructions, data structures, program modules, and/or other data types in a modulated data signal such as a carrier wave or other transport mechanism and includes any information delivery media. The term “modulated data signal” may refer to a signal that has one or more of its characteristics set or changed in such a manner as to encode information in the signal. By way of example, and not limitation, the computer storage media may include wired media such as a wired network or direct-wired connection, and wireless media such as acoustic, RF, infrared and other wireless media. Combinations of any of the above should also be included within the scope of computer-readable media.

The CPU(s) 1106 may be configured to execute at least some of the computer-readable instructions to control one or more components of the computing device 1100 to perform one or more of the methods and/or processes described herein. The CPU(s) 1106 may each include one or more cores (e.g., one, two, four, eight, twenty-eight, seventy-two, etc.) that are capable of handling a multitude of software threads simultaneously. The CPU(s) 1106 may include any type of processor, and may include different types of processors depending on the type of computing device 1100 implemented (e.g., processors with fewer cores for mobile devices and processors with more cores for servers). For example, depending on the type of computing device 1100, the processor may be an Advanced RISC Machines (ARM) processor implemented using Reduced Instruction Set Computing (RISC) or an x86 processor implemented using Complex Instruction Set Computing (CISC). The computing device 1100 may include one or more CPUs 1106 in addition to one or more microprocessors or supplementary co-processors, such as math co-processors.

In addition to or alternatively from the CPU(s) 1106, the GPU(s) 1108 may be configured to execute at least some of the computer-readable instructions to control one or more components of the computing device 1100 to perform one or more of the methods and/or processes described herein. One or more of the GPU(s) 1108 may be an integrated GPU (e.g., with one or more of the CPU(s) 1106 and/or one or more of the GPU(s) 1108 may be a discrete GPU. In embodiments, one or more of the GPU(s) 1108 may be a coprocessor of one or more of the CPU(s) 1106. The GPU(s) 1108 may be used by the computing device 1100 to render graphics (e.g., 3D graphics) or perform general purpose computations. For example, the GPU(s) 1108 may be used for General-Purpose computing on GPUs (GPGPU). The GPU(s) 1108 may include hundreds or thousands of cores that are capable of handling hundreds or thousands of software threads simultaneously. The GPU(s) 1108 may generate pixel data for output images in response to rendering commands (e.g., rendering commands from the CPU(s) 1106 received via a host interface). The GPU(s) 1108 may include graphics memory, such as display memory, for storing pixel data or any other suitable data, such as GPGPU data. The display memory may be included as part of the memory 1104. The GPU(s) 1108 may include two or more GPUs operating in parallel (e.g., via a link). The link may directly connect the GPUs (e.g., using NVLINK) or may connect the GPUs through a switch (e.g., using NVSwitch). When combined together, each GPU 1108 may generate pixel data or GPGPU data for different portions of an output or for different outputs (e.g., a first GPU for a first image and a second GPU for a second image). Each GPU may include its own memory, or may share memory with other GPUs.

In addition to or alternatively from the CPU(s) 1106 and/or the GPU(s) 1108, the logic unit(s) 1120 may be configured to execute at least some of the computer-readable instructions to control one or more components of the computing device 1100 to perform one or more of the methods and/or processes described herein. In embodiments, the CPU(s) 1106, the GPU(s) 1108, and/or the logic unit(s) 1120 may discretely or jointly perform any combination of the methods, processes and/or portions thereof. One or more of the logic units 1120 may be part of and/or integrated in one or more of the CPU(s) 1106 and/or the GPU(s) 1108 and/or one or more of the logic units 1120 may be discrete components or otherwise external to the CPU(s) 1106 and/or the GPU(s) 1108. In embodiments, one or more of the logic units 1120 may be a coprocessor of one or more of the CPU(s) 1106 and/or one or more of the GPU(s) 1108.

Examples of the logic unit(s) 1120 include one or more processing cores and/or components thereof, such as Data Processing Units (DPUs), Tensor Cores (TCs), Tensor Processing Units(TPUs), Pixel Visual Cores (PVCs), Vision Processing Units (VPUs), Graphics Processing Clusters (GPCs), Texture Processing Clusters (TPCs), Streaming Multiprocessors (SMs), Tree Traversal Units (TTUs), Artificial Intelligence Accelerators (AIAs), Deep Learning Accelerators (DLAs), Arithmetic-Logic Units (ALUs), Application-Specific Integrated Circuits (ASICs), Floating Point Units (FPUs), input/output (I/O) elements, peripheral component interconnect (PCI) or peripheral component interconnect express (PCIe) elements, and/or the like.

The communication interface 1110 may include one or more receivers, transmitters, and/or transceivers that enable the computing device 1100 to communicate with other computing devices via an electronic communication network, included wired and/or wireless communications. The communication interface 1110 may include components and functionality to enable communication over any of a number of different networks, such as wireless networks (e.g., Wi-Fi, Z-Wave, Bluetooth, Bluetooth LE, ZigBee, etc.), wired networks (e.g., communicating over Ethernet or InfiniBand), low-power wide-area networks (e.g., LoRaWAN, SigFox, etc.), and/or the Internet. In one or more embodiments, logic unit(s) 1120 and/or communication interface 1110 may include one or more data processing units (DPUs) to transmit data received over a network and/or through interconnect system 1102 directly to (e.g., a memory of) one or more GPU(s) 1108.

The I/O ports 1112 may enable the computing device 1100 to be logically coupled to other devices including the I/O components 1114, the presentation component(s) 1118, and/or other components, some of which may be built in to (e.g., integrated in) the computing device 1100. Illustrative I/O components 1114 include a microphone, mouse, keyboard, joystick, game pad, game controller, satellite dish, scanner, printer, wireless device, etc. The I/O components 1114 may provide a natural user interface (NUI) that processes air gestures, voice, or other physiological inputs generated by a user. In some instances, inputs may be transmitted to an appropriate network element for further processing. An NUI may implement any combination of speech recognition, stylus recognition, facial recognition, biometric recognition, gesture recognition both on screen and adjacent to the screen, air gestures, head and eye tracking, and touch recognition (as described in more detail below) associated with a display of the computing device 1100. The computing device 1100 may be include depth cameras, such as stereoscopic camera systems, infrared camera systems, RGB camera systems, touchscreen technology, and combinations of these, for gesture detection and recognition. Additionally, the computing device 1100 may include accelerometers or gyroscopes (e.g., as part of an inertia measurement unit (IMU)) that enable detection of motion. In some examples, the output of the accelerometers or gyroscopes may be used by the computing device 1100 to render immersive augmented reality or virtual reality.

The power supply 1116 may include a hard-wired power supply, a battery power supply, or a combination thereof. The power supply 1116 may provide power to the computing device 1100 to enable the components of the computing device 1100 to operate.

The presentation component(s) 1118 may include a display (e.g., a monitor, a touch screen, a television screen, a heads-up-display (HUD), other display types, or a combination thereof), speakers, and/or other presentation components. The presentation component(s) 1118 may receive data from other components (e.g., the GPU(s) 1108, the CPU(s) 1106, DPUs, etc.), and output the data (e.g., as an image, video, sound, etc.).

### Example Data Center

FIG. 12 illustrates an example data center 1200 that may be used in at least one embodiments of the present disclosure. The data center 1200 may include a data center infrastructure layer 1210, a framework layer 1220, a software layer 1230, and/or an application layer 1240.

As shown in FIG. 12, the data center infrastructure layer 1210 may include a resource orchestrator 1212, grouped computing resources 1214, and node computing resources (“node C.R.s”) 1216(1)-1216(N), where “N” represents any whole, positive integer. In at least one embodiment, node C.R.s 1216(1)-1216(N) may include, but are not limited to, any number of central processing units (CPUs) or other processors (including DPUs, accelerators, field programmable gate arrays (FPGAs), graphics processors or graphics processing units (GPUs), etc.), memory devices (e.g., dynamic read-only memory), storage devices (e.g., solid state or disk drives), network input/output (NW I/O) devices, network switches, virtual machines (VMs), power modules, and/or cooling modules, etc. In some embodiments, one or more node C.R.s from among node C.R.s 1216(1)-1216(N) may correspond to a server having one or more of the above-mentioned computing resources. In addition, in some embodiments, the node C.R.s 1216(1)-12161(N) may include one or more virtual components, such as vGPUs, vCPUs, and/or the like, and/or one or more of the node C.R.s 1216(1)-1216(N) may correspond to a virtual machine (VM).

In at least one embodiment, grouped computing resources 1214 may include separate groupings of node C.R.s 1216 housed within one or more racks (not shown), or many racks housed in data centers at various geographical locations (also not shown). Separate groupings of node C.R.s 1216 within grouped computing resources 1214 may include grouped compute, network, memory or storage resources that may be configured or allocated to support one or more workloads. In at least one embodiment, several node C.R.s 1216 including CPUs, GPUs, DPUs, and/or other processors may be grouped within one or more racks to provide compute resources to support one or more workloads. The one or more racks may also include any number of power modules, cooling modules, and/or network switches, in any combination.

The resource orchestrator 1212 may configure or otherwise control one or more node C.R.s 1216(1)-1216(N) and/or grouped computing resources 1214. In at least one embodiment, resource orchestrator 1212 may include a software design infrastructure (SDI) management entity for the data center 1200. The resource orchestrator 1212 may include hardware, software, or some combination thereof.

In at least one embodiment, as shown in FIG. 12, framework layer 1220 may include a job scheduler 1233, a configuration manager 1234, a resource manager 1236, and/or a distributed file system 1238. The framework layer 1220 may include a framework to support software 1232 of software layer 1230 and/or one or more application(s) 1242 of application layer 1240. The software 1232 or application(s) 1242 may respectively include web-based service software or applications, such as those provided by Amazon Web Services, Google Cloud and Microsoft Azure. The framework layer 1220 may be, but is not limited to, a type of free and open-source software web application framework such as Apache Spark™ (hereinafter “Spark”) that may utilize distributed file system 1238 for large-scale data processing (e.g., “big data”). In at least one embodiment, job scheduler 1233 may include a Spark driver to facilitate scheduling of workloads supported by various layers of data center 1200. The configuration manager 1234 may be capable of configuring different layers such as software layer 1230 and framework layer 1220 including Spark and distributed file system 1238 for supporting large-scale data processing. The resource manager 1236 may be capable of managing clustered or grouped computing resources mapped to or allocated for support of distributed file system 1238 and job scheduler 1233. In at least one embodiment, clustered or grouped computing resources may include grouped computing resource 1214 at data center infrastructure layer 1210. The resource manager 1236 may coordinate with resource orchestrator 1212 to manage these mapped or allocated computing resources.

In at least one embodiment, software 1232 included in software layer 1230 may include software used by at least portions of node C.R.s 1216(1)-1216(N), grouped computing resources 1214, and/or distributed file system 1238 of framework layer 1220. One or more types of software may include, but are not limited to, Internet web page search software, e-mail virus scan software, database software, and streaming video content software.

In at least one embodiment, application(s) 1242 included in application layer 1240 may include one or more types of applications used by at least portions of node C.R.s 1216(1)-1216(N), grouped computing resources 1214, and/or distributed file system 1238 of framework layer 1220. One or more types of applications may include, but are not limited to, any number of a genomics application, a cognitive compute, and a machine learning application, including training or inferencing software, machine learning framework software (e.g., PyTorch, TensorFlow, Caffe, etc.), and/or other machine learning applications used in conjunction with one or more embodiments.

In at least one embodiment, any of configuration manager 1234, resource manager 1236, and resource orchestrator 1212 may implement any number and type of self-modifying actions based on any amount and type of data acquired in any technically feasible fashion. Self-modifying actions may relieve a data center operator of data center 1200 from making possibly bad configuration decisions and possibly avoiding underutilized and/or poor performing portions of a data center.

The data center 1200 may include tools, services, software or other resources to train one or more machine learning models or predict or infer information using one or more machine learning models according to one or more embodiments described herein. For example, a machine learning model(s) may be trained by calculating weight parameters according to a neural network architecture using software and/or computing resources described above with respect to the data center 1200. In at least one embodiment, trained or deployed machine learning models corresponding to one or more neural networks may be used to infer or predict information using resources described above with respect to the data center 1200 by using weight parameters calculated through one or more training techniques, such as but not limited to those described herein.

In at least one embodiment, the data center 1200 may use CPUs, application-specific integrated circuits (ASICs), GPUs, FPGAs, and/or other hardware (or virtual compute resources corresponding thereto) to perform training and/or inferencing using above-described resources. Moreover, one or more software and/or hardware resources described above may be configured as a service to allow users to train or performing inferencing of information, such as image recognition, speech recognition, or other artificial intelligence services.

### Example Network Environments

Network environments suitable for use in implementing embodiments of the disclosure may include one or more client devices, servers, network attached storage (NAS), other backend devices, and/or other device types. The client devices, servers, and/or other device types (e.g., each device) may be implemented on one or more instances of the computing device(s) 1100 of FIG. 11—e.g., each device may include similar components, features, and/or functionality of the computing device(s) 1100. In addition, where backend devices (e.g., servers, NAS, etc.) are implemented, the backend devices may be included as part of a data center 1200, an example of which is described in more detail herein with respect to FIG. 12.

Components of a network environment may communicate with each other via a network(s), which may be wired, wireless, or both. The network may include multiple networks, or a network of networks. By way of example, the network may include one or more Wide Area Networks (WANs), one or more Local Area Networks (LANs), one or more public networks such as the Internet and/or a public switched telephone network (PSTN), and/or one or more private networks. Where the network includes a wireless telecommunications network, components such as a base station, a communications tower, or even access points (as well as other components) may provide wireless connectivity.

Compatible network environments may include one or more peer-to-peer network environments—in which case a server may not be included in a network environment—and one or more client-server network environments—in which case one or more servers may be included in a network environment. In peer-to-peer network environments, functionality described herein with respect to a server(s) may be implemented on any number of client devices.

In at least one embodiment, a network environment may include one or more cloud-based network environments, a distributed computing environment, a combination thereof, etc. A cloud-based network environment may include a framework layer, a job scheduler, a resource manager, and a distributed file system implemented on one or more of servers, which may include one or more core network servers and/or edge servers. A framework layer may include a framework to support software of a software layer and/or one or more application(s) of an application layer. The software or application(s) may respectively include web-based service software or applications. In embodiments, one or more of the client devices may use the web-based service software or applications (e.g., by accessing the service software and/or applications via one or more application programming interfaces (APIs)). The framework layer may be, but is not limited to, a type of free and open-source software web application framework such as that may use a distributed file system for large-scale data processing (e.g., “big data”).

A cloud-based network environment may provide cloud computing and/or cloud storage that carries out any combination of computing and/or data storage functions described herein (or one or more portions thereof). Any of these various functions may be distributed over multiple locations from central or core servers (e.g., of one or more data centers that may be distributed across a state, a region, a country, the globe, etc.). If a connection to a user (e.g., a client device) is relatively close to an edge server(s), a core server(s) may designate at least a portion of the functionality to the edge server(s). A cloud-based network environment may be private (e.g., limited to a single organization), may be public (e.g., available to many organizations), and/or a combination thereof (e.g., a hybrid cloud environment).

The client device(s) may include at least some of the components, features, and functionality of the example computing device(s) 1100 described herein with respect to FIG. 11. By way of example and not limitation, a client device may be embodied as a Personal Computer (PC), a laptop computer, a mobile device, a smartphone, a tablet computer, a smart watch, a wearable computer, a Personal Digital Assistant (PDA), an MP3 player, a virtual reality headset, a Global Positioning System (GPS) or device, a video player, a video camera, a surveillance device or system, a vehicle, a boat, a flying vessel, a virtual machine, a drone, a robot, a handheld communications device, a hospital device, a gaming device or system, an entertainment system, a vehicle computer system, an embedded system controller, a remote control, an appliance, a consumer electronic device, a workstation, an edge device, any combination of these delineated devices, or any other suitable device.

The disclosure may be described in the general context of computer code or machine-useable instructions, including computer-executable instructions such as program modules, being executed by a computer or other machine, such as a personal data assistant or other handheld device. Generally, program modules including routines, programs, objects, components, data structures, etc., refer to code that perform particular tasks or implement particular abstract data types. The disclosure may be practiced in a variety of system configurations, including hand-held devices, consumer electronics, general-purpose computers, more specialty computing devices, etc. The disclosure may also be practiced in distributed computing environments where tasks are performed by remote-processing devices that are linked through a communications network.

As used herein, a recitation of “and/or” with respect to two or more elements should be interpreted to mean only one element, or a combination of elements. For example, “element A, element B, and/or element C” may include only element A, only element B, only element C, element A and element B, element A and element C, element B and element C, or elements A, B, and C. In addition, “at least one of element A or element B” may include at least one of element A, at least one of element B, or at least one of element A and at least one of element B. Further, “at least one of element A and element B” may include at least one of element A, at least one of element B, or at least one of element A and at least one of element B.

The subject matter of the present disclosure is described with specificity herein to meet statutory requirements. However, the description itself is not intended to limit the scope of this disclosure. Rather, the inventors have contemplated that the claimed subject matter might also be embodied in other ways, to include different steps or combinations of steps similar to the ones described in this document, in conjunction with other present or future technologies. Moreover, although the terms “step” and/or “block” may be used herein to connote different elements of methods employed, the terms should not be interpreted as implying any particular order among or between various steps herein disclosed unless and except when the order of individual steps is explicitly described.

### EXAMPLE PARAGRAPHS

A. A method comprising: applying, as input to one or more deep neural networks (DNNs), image data representing an image depicting one or more traffic light devices; determining, using one or more component heads of the one or more DNNs, one or more attributes associated with the one or more traffic light devices; determining, using a fusion head of the one or more DNNs and based at least on the one or more attributes, one or more classifications associated with the one or more traffic light devices; and causing a machine to perform one or more control operations based on at least one of the one or more attributes or the one or more classifications associated with the one or more traffic light devices.
B. The method as recited in paragraph A, wherein the one or more attributes associated with the one or more traffic light devices include at least one of: one or more orientations of the one or more traffic light devices; one or more housing shapes of the one or more traffic light devices; one or more active bulb colors of the one or more traffic light devices; or one or more active bulb shapes of the one or more traffic light devices.
C. The method as recited in any one of paragraphs A-B, wherein the one or more component heads include at least a component head that is to output a combination of detected attributes associated with the one or more traffic light devices.
D. The method as recited in any one of paragraphs A-C, wherein the detected attributes of the combination include at least one or more color and shape combinations of one or more active bulbs of the one or more traffic light devices.
E. The method as recited in any one of paragraphs A-D, wherein the one or more classifications associated with the one or more traffic light devices include at least a subset of the one or more attributes, the one or more classifications determined using the fusion head based at least on a combination of the one or more attributes.
F. The method as recited in any one of paragraphs A-E, further comprising: generating, based at least on the one or more DNNs processing the image data, one or more component feature vectors corresponding to the one or more traffic light devices depicted in the image, wherein: the one or more attributes are determined using the one or more component heads based at least on applying the one or more component feature vectors to the one or more component heads, and the one or more attributes are determined using the fusion head based at least on applying, to the fusion head, a combined feature vector including a combination of the one or more component feature vectors.
G. The method as recited in any one of paragraphs A-F, wherein the one or more component heads include at least a first component head and a second component head, the first component head to classify one or more first attributes of the one or more traffic light devices and the second component head to classify one or more second attributes of the one or more traffic light devices.
H. A system comprising: one or more processors to: determine, based at least on one or more first layers of a machine learning model processing sensor data obtained using one or more sensors having fields of view or sensory fields including a traffic light device, first data corresponding to one or more first attributes associated with the traffic light device; determine, based at least on one or more second layers of the machine learning model processing the first data, second data corresponding to one or more second attributes associated with the traffic light device; and perform one or more operations associated with a machine based on at least one of the one or more first attributes or the one or more second attributes.
I. The system as recited in paragraph H, wherein at least one of the one or more first attributes or the one or more second attributes include at least one of: an orientation of the traffic light device; a housing shape of the traffic light device; active bulb colors of the traffic light device; active bulb shapes of the traffic light device; a bulb count of the traffic light device; a road user of the traffic light device; or a blinking state of the traffic light device.
J. The system as recited in any one of paragraphs H-I, the one or more processors further to: determine, using one or more fusion layers of the machine learning model, a classification associated with the traffic light device, wherein the performance of the one or more operations associated with the machine is further based at least on the classification.
K. The system as recited in any one of paragraphs H-J, wherein the determination of the classification associated with the traffic light device is based on a combination of at least one of: the one or more first attributes and the one or more second attributes; or a first feature vector and one or more second feature vectors, the first feature vector applied as input to the one or more first layers and the one or more second features vectors applied as input to the one or more second layers.
L. The system as recited in any one of paragraphs H-K, wherein the one or more first attributes determined using the one or more first layers include at least one or more color and shape combinations of one or more active bulbs of the traffic light device.
M. The system as recited in any one of paragraphs H-L, wherein at least one of the one or more first attributes or the one or more second attributes include one or more housing shapes associated with the traffic light device, the one or more housing shapes corresponding to at least one of: a vertical housing shape; a horizontal housing shape; a doghouse housing shape; or a pedestrian hybrid beacon housing shape.
N. The system as recited in any one of paragraphs H-M, wherein the machine learning model is trained, at least, by: obtaining an image depicting a second traffic light device; updating one or more portions of the image to generate an updated image depicting the second traffic light device having one or more updated attributes; and updating one or more parameters associated with the one or more first layers or the one or more second layers of the machine learning model based at least on applying the updated image as a training input to the machine learning model.
O. The system as recited in any one of paragraphs H-N, wherein the system is comprised in at least one of: a control system for an autonomous or semi-autonomous machine; a perception system for an autonomous or semi-autonomous machine; a system for performing one or more simulation operations; a system for performing one or more digital twin operations; a system for performing light transport simulation; a system for performing collaborative content creation for 3D assets; a system for performing one or more deep learning operations; a system implemented using an edge device; a system implemented using a robot; a system for performing one or more generative AI operations; a system for performing operations using a large language model; a system for performing operations using one or more vision language models (VLMs); a system for performing operations using one or more multi-modal language models; a system for using or deploying one or more inference microservices; a system for performing one or more conversational AI operations; a system for generating synthetic data; a system for presenting at least one of virtual reality content, augmented reality content, or mixed reality content; a system incorporating one or more virtual machines (VMs); a system implemented at least partially in a data center; or a system implemented at least partially using cloud computing resources.
P. One or more processors comprising: processing circuitry to perform one or more operations corresponding to a machine based at least on one or more attributes associated with a first traffic light device, the one or more attributes determined using one or more machine learning models, the one or more machine learning models trained, at least, by: obtaining an image depicting a second traffic light device having one or more first attributes; updating one or more portions of the image to generate an updated image, the updated image depicting the second traffic light device having one or more second attributes; and updating one or more parameters associated with one or more component heads of the one or more machine learning models based at least on applying the updated image as a training input to the one or more machine learning models.
Q. The one or more processors as recited in paragraph P, wherein the updating of the one or more portions of the image to generate the updated image comprises modifying one or more values of one or more pixels of the image corresponding to one or more active bulbs of the second traffic light device, wherein the one or more values are modified such that the one or more active bulbs are depicted as non-active bulbs in the updated image.
R. The one or more processors as recited in any one of paragraphs P-Q, wherein the image depicts the second traffic light device in a first state and the updating of the one or more portions of the image to generate the updated image comprises updating the image such that the updated image depicts the second traffic light device in a second state that is different from the first state.
S. The one or more processors as recited in any one of paragraphs P-R, wherein the updating of the one or more portions of the image to generate the updated image comprises at least one of: updating one or more shapes of one or more bulbs of the second traffic light device; updating an orientation of the second traffic light device; updating a housing shape of the second traffic light device; or updating a number of bulbs associated with the second traffic light device.
T. The one or more processors as recited in any one of paragraphs P-S, wherein the one or more processors are comprised in at least one of: a control system for an autonomous or semi-autonomous machine; a perception system for an autonomous or semi-autonomous machine; a system for performing one or more simulation operations; a system for performing one or more digital twin operations; a system for performing light transport simulation; a system for performing collaborative content creation for 3D assets; a system for performing one or more deep learning operations; a system implemented using an edge device; a system implemented using a robot; a system for performing one or more generative AI operations; a system for performing operations using a large language model; a system for performing operations using one or more vision language models (VLMs); a system for performing operations using one or more multi-modal language models; a system for using or deploying one or more inference microservices; a system for performing one or more conversational AI operations; a system for generating synthetic data; a system for presenting at least one of virtual reality content, augmented reality content, or mixed reality content; a system incorporating one or more virtual machines (VMs); a system implemented at least partially in a data center; or a system implemented at least partially using cloud computing resources.

What is claimed is:

1. A method comprising:
applying, as input to one or more deep neural networks (DNNs), image data representing an image depicting one or more traffic light devices;
determining, using one or more component heads of the one or more DNNs, one or more attributes associated with the one or more traffic light devices;
determining, using a fusion head of the one or more DNNs and based at least on the one or more attributes, one or more classifications associated with the one or more traffic light devices; and
causing a machine to perform one or more control operations based on at least one of the one or more attributes or the one or more classifications associated with the one or more traffic light devices.

2. The method of claim 1, wherein the one or more attributes associated with the one or more traffic light devices include at least one of:
one or more orientations of the one or more traffic light devices;
one or more housing shapes of the one or more traffic light devices;
one or more active bulb colors of the one or more traffic light devices; or
one or more active bulb shapes of the one or more traffic light devices.

3. The method of claim 1, wherein the one or more component heads include at least a component head that is to output a combination of detected attributes associated with the one or more traffic light devices.

4. The method of claim 3, wherein the detected attributes of the combination include at least one or more color and shape combinations of one or more active bulbs of the one or more traffic light devices.

5. The method of claim 1, wherein the one or more classifications associated with the one or more traffic light devices include at least a subset of the one or more attributes, the one or more classifications determined using the fusion head based at least on a combination of the one or more attributes.

6. The method of claim 1, further comprising:
generating, based at least on the one or more DNNs processing the image data, one or more component feature vectors corresponding to the one or more traffic light devices depicted in the image,
wherein:
the one or more attributes are determined using the one or more component heads based at least on applying the one or more component feature vectors to the one or more component heads, and
the one or more attributes are determined using the fusion head based at least on applying, to the fusion head, a combined feature vector including a combination of the one or more component feature vectors.

7. The method of claim 1, wherein the one or more component heads include at least a first component head and a second component head, the first component head to classify one or more first attributes of the one or more traffic light devices and the second component head to classify one or more second attributes of the one or more traffic light devices.

8. A system comprising:
one or more processors to:
determine, based at least on one or more first layers of a machine learning model processing sensor data obtained using one or more sensors having fields of view or sensory fields including a traffic light device, first data corresponding to one or more first attributes associated with the traffic light device;
determine, based at least on one or more second layers of the machine learning model processing the first data, second data corresponding to one or more second attributes associated with the traffic light device; and
perform one or more operations associated with a machine based on at least one of the one or more first attributes or the one or more second attributes.

9. The system of claim 8, wherein at least one of the one or more first attributes or the one or more second attributes include at least one of:
an orientation of the traffic light device;
a housing shape of the traffic light device;
active bulb colors of the traffic light device;
active bulb shapes of the traffic light device;
a bulb count of the traffic light device;
a road user of the traffic light device; or
a blinking state of the traffic light device.

10. The system of claim 8, the one or more processors further to:
determine, using one or more fusion layers of the machine learning model, a classification associated with the traffic light device,
wherein the performance of the one or more operations associated with the machine is further based at least on the classification.

11. The system of claim 10, wherein the determination of the classification associated with the traffic light device is based on a combination of at least one of:
the one or more first attributes and the one or more second attributes; or
a first feature vector and one or more second feature vectors, the first feature vector applied as input to the one or more first layers and the one or more second features vectors applied as input to the one or more second layers.

12. The system of claim 8, wherein the one or more first attributes determined using the one or more first layers include at least one or more color and shape combinations of one or more active bulbs of the traffic light device.

13. The system of claim 8, wherein at least one of the one or more first attributes or the one or more second attributes include one or more housing shapes associated with the traffic light device, the one or more housing shapes corresponding to at least one of:
a vertical housing shape;
a horizontal housing shape;
a doghouse housing shape; or
a pedestrian hybrid beacon housing shape.

14. The system of claim 8, wherein the machine learning model is trained, at least, by:
obtaining an image depicting a second traffic light device;
updating one or more portions of the image to generate an updated image depicting the second traffic light device having one or more updated attributes; and
updating one or more parameters associated with the one or more first layers or the one or more second layers of the machine learning model based at least on applying the updated image as a training input to the machine learning model.

15. The system of claim 8, wherein the system is comprised in at least one of:
a control system for an autonomous or semi-autonomous machine;
a perception system for an autonomous or semi-autonomous machine;
a system for performing one or more simulation operations;
a system for performing one or more digital twin operations;
a system for performing light transport simulation;
a system for performing collaborative content creation for 3D assets;
a system for performing one or more deep learning operations;
a system implemented using an edge device;
a system implemented using a robot;
a system for performing one or more generative AI operations;
a system for performing operations using a large language model;
a system for performing operations using one or more vision language models (VLMs);
a system for performing operations using one or more multi-modal language models;
a system for using or deploying one or more inference microservices;
a system for performing one or more conversational AI operations;
a system for generating synthetic data;
a system for presenting at least one of virtual reality content, augmented reality content, or mixed reality content;
a system incorporating one or more virtual machines (VMs);
a system implemented at least partially in a data center; or
a system implemented at least partially using cloud computing resources.

16. One or more processors comprising:
processing circuitry to perform one or more operations corresponding to a machine based at least on one or more attributes associated with a first traffic light device, the one or more attributes determined using one or more machine learning models, the one or more machine learning models trained, at least, by:
obtaining an image depicting a second traffic light device having one or more first attributes;
updating one or more portions of the image to generate an updated image, the updated image depicting the second traffic light device having one or more second attributes; and
updating one or more parameters associated with one or more component heads of the one or more machine learning models based at least on applying the updated image as a training input to the one or more machine learning models.

17. The one or more processors of claim 16, wherein the updating of the one or more portions of the image to generate the updated image comprises modifying one or more values of one or more pixels of the image corresponding to one or more active bulbs of the second traffic light device, wherein the one or more values are modified such that the one or more active bulbs are depicted as non-active bulbs in the updated image.

18. The one or more processors of claim 16, wherein the image depicts the second traffic light device in a first state and the updating of the one or more portions of the image to generate the updated image comprises updating the image such that the updated image depicts the second traffic light device in a second state that is different from the first state.

19. The one or more processors of claim 16, wherein the updating of the one or more portions of the image to generate the updated image comprises at least one of:
updating one or more shapes of one or more bulbs of the second traffic light device;
updating an orientation of the second traffic light device;
updating a housing shape of the second traffic light device; or
updating a number of bulbs associated with the second traffic light device.

20. The one or more processors of claim 16, wherein the one or more processors are comprised in at least one of:
a control system for an autonomous or semi-autonomous machine;
a perception system for an autonomous or semi-autonomous machine;
a system for performing one or more simulation operations;
a system for performing one or more digital twin operations;
a system for performing light transport simulation;
a system for performing collaborative content creation for 3D assets;
a system for performing one or more deep learning operations;
a system implemented using an edge device;
a system implemented using a robot;
a system for performing one or more generative AI operations;
a system for performing operations using a large language model;
a system for performing operations using one or more vision language models (VLMs);
a system for performing operations using one or more multi-modal language models;
a system for using or deploying one or more inference microservices;
a system for performing one or more conversational AI operations;
a system for generating synthetic data;
a system for presenting at least one of virtual reality content, augmented reality content, or mixed reality content;
a system incorporating one or more virtual machines (VMs);
a system implemented at least partially in a data center; or
a system implemented at least partially using cloud computing resources.
